(19) United States
(12) Patent Application Publication
(10) Pub. No.: US 2007/0259635 A1
(43) Pub. Date: Nov. 8, 2007

(54) Method and system for using resources in a multi-cell communication system

(75) Inventors: Seong-Keun Oh, Suwon-si (KR); Ki-Bum Kwon, Seongnam-si (KR); Ki-Tae Kim, Seoul (KR)

Correspondence Address: THE FARRELL LAW FIRM, P.C., 333 EARLE OVINGTON BOULEVARD, SUITE 701, UNIONDALE, NY, 11553, US

(73) Assignees: Samsung Electronics Co., Ltd., Suwon-si (KR); Seoul National University Industry Foundation, Seoul (KR)

(21) Appl. No.: 11/789,985

(22) Filed: Apr. 26, 2007

(30) Foreign Application Priority Data
Apr. 26, 2006 (KR) 2006-37869

(51) Int. Cl. H04B 1/18

(52) U.S. Cl. 455/186.1

(57) ABSTRACT

A method for using resources in a multi-cell communication system is disclosed. The method includes dividing a frequency band used in the multi-cell communication system into a plurality of unit subchannels; and allocating the unit subchannels according to a sequence which is predefined in each cell in an allocation order of the unit subchannels depending on identifier information of the multiple cells.

### PRIORITY

This application claims priority under 35 U.S.C. §119(a) to a Korean Patent Application filed in the Korean Intellectual Property Office on Apr. 26, 2006 and assigned Serial No. 2006-37869, the disclosure of which is incorporated herein by reference.

### BACKGROUND OF THE INVENTION

1. Field of the Invention

The present invention relates generally to a multi-cell communication system, and in particular, to a method and system using resources for minimizing the occurrence of Inter Cell Interference (ICI) in a communication system having a multi-cell configuration.

2. Description of the Related Art

In a multi-cell communication system, multiple cells constituting the multi-cell communication system share the limited resources, which include frequency resources, code resources, time slot resources and the like, and some cells reuse the same resources, thereby causing the occurrence of ICI between the multiple cells, especially between adjacent cells. The reuse of frequency resources, code resources and time slot resources by these cells causes performance degradation due to the ICI, but can increase the total capacity of the multi-cell communication system. The ICI is considerable in the multi-cell communication system with a frequency reuse factor=1.

More specifically, in the multi-cell communication system having multiple cells that share a frequency band, in order to reuse frequency resources while reducing the ICI, the frequency band is divided into as many sub-frequency bands as the frequency reuse factor. In addition, the sub-frequency bands are allocated to as many cells as the number of the sub-frequency bands, including a serving cell among the multiple cells, and some cells among the other cells except for the cells allocated the sub-frequency bands reuse the sub-frequency bands taking into account the interference to/from other cells.

In the multi-cell communication system, a decrease in the frequency reuse ratio, i.e. an excess of the frequency reuse factor over 1, reduces the ICI, but reduces the amount of frequency resources available in one cell, causing a decrease in the total capacity of the multi-cell communication system. On the contrary, use of the frequency reuse factor=1, i.e. use of the same frequency band by all cells constituting the multi-cell communication system, increases the ICI, but increases the amount of frequency resources available even in one cell, causing an increase in the total capacity of the multi-cell communication system.

In the next generation communication system, extensive research is being conducted to provide users with high-rate services having various Quality of Service (QoS) levels. Particularly, in the next generation communication system, a study is being conducted to support high-speed services capable of guaranteeing mobility and QoS for a Broadband Wireless Access (BWA) communication system such as a Wireless Local Area Network (WLAN) system and a Wireless Metropolitan Area Network (WMAN) system.

Therefore, in the BWA communication system, active research is being conducted on Orthogonal Frequency Division Multiplexing (OFDM)/Orthogonal Frequency Division Multiple Access (OFDMA) as a scheme suitable for high-speed data transmission in wire/wireless channels, and an Institute of Electrical and Electronics Engineers (IEEE) 802.16a/d communication system and an IEEE 802.16e communication system are the typical BWA communication systems. The IEEE 802.16e communication system employing OFDM/OFDMA, if it has multiple cells, may suffer ICI between the multiple cells. In particular, the IEEE 802.16e communication system forms subchannels in the entire frequency band, establishes the formed subchannels differently for each cell, and then averages the ICI. For example, one subchannel in an arbitrary cell uniformly affects all subchannels in other adjacent cells, and an increase in loading ratio of the arbitrary cell increases the average ICI of all subchannels in the adjacent cells. Therefore, there is a need for a resource allocation scheme capable of minimizing ICI between cells and increasing resource efficiency in the multi-cell environment.

### SUMMARY OF THE INVENTION

An aspect of the present invention is to address at least the problems and/or disadvantages above and to provide at least the advantages described below. Accordingly, an aspect of the present invention is to provide a resource using method and system for minimizing the occurrence of ICI in a multi-cell communication system.

Another aspect of the present invention is to provide a resource using method and system for enabling efficient use of resources in a multi-cell communication system.

According to one aspect of the present invention, there is provided a method for using resources in a multi-cell communication system. The method includes dividing a frequency band used in the multi-cell communication system into a plurality of unit subchannels; and allocating the unit subchannels according to a sequence which is predefined in each cell in an allocation order of the unit subchannels depending on identifier information of the multiple cells.

According to another aspect of the present invention, there is provided a method for using resources in a multi-cell communication system. The method includes dividing resources used in the multi-cell communication system into a plurality of unit subchannels; and periodically reallocating the unit subchannels according to a resource allocation sequence using a Dynamic Channel Allocation (DCA) scheme for each cell among the multiple cells.

According to a further aspect of the present invention, there is provided a system for using resources in a multi-cell communication system. The system includes a scheduler for dividing a frequency band used in the multi-cell communication system into a plurality of unit subchannels, and allocating the unit subchannels according to a sequence which is predefined in each cell in an allocation order of the unit subchannels depending on identifier information of the multiple cells.

### BRIEF DESCRIPTION OF THE DRAWINGS

The above and other aspects, features and advantages of the present invention will become more apparent from the following detailed description when taken in conjunction with the accompanying drawings in which:

FIGS. 1A to 1G illustrate resource allocation schemes for multiple cells in a multi-cell communication system according to an embodiment of the present invention;

FIGS. 2A to 2D illustrate resource allocation methods in which a multi-cell communication system allocates resources in units of subchannels in the entire frequency band according to an embodiment of the present invention;

FIGS. 3A to 3F illustrate configuration schemes for subchannels in a multi-cell communication system according to an embodiment of the present invention;

FIGS. 4A and 4B illustrate schemes in which a multi-cell communication system allocates resources to users existing in the multiple cells according to an embodiment of the present invention;

FIGS. 5A to 5G illustrate structures of sequences predefined for subchannel allocation in a multi-cell communication system according to an embodiment of the present invention;

FIGS. 6A to 6G illustrate schemes in which a multi-cell communication system allocates unit subchannels depending on type of subchannel allocation sequences according to an embodiment of the present invention;

FIGS. 7A to 7R illustrate an operation in which a multi-cell communication system allocates unit subchannels using subchannel allocation sequences according to an embodiment of the present invention; and

FIGS. 8A to 8J illustrate DCA in a multi-cell communication system according to an embodiment of the present invention.

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a resource using method and system for minimizing the occurrence of Inter Cell Interference (ICI) and enabling efficient use of resources in a multi-cell communication system. In addition, the present invention provides a resource using method and system for allocating resources according to cell-specific sequences uniquely defined for cells in a multi-cell communication system, thereby minimizing the occurrence of ICI and facilitating efficient use of resources. Also, the present invention provides a resource using method and system for allocating resources using a Dynamic Channel Allocation (DCA) scheme when there is a change in communication environment, for example, when there is a change in the number of users existing in the cell due to handover, communication termination, communication interrupt, and the like, in a multi-cell communication system, thereby minimizing the occurrence of ICI and securing efficient use of resources.

According to an embodiment of the present invention, the multi-cell communication system divides available resources, for example, frequency resources, i.e. a frequency band, into unit subchannels, and uses the unit subchannels independently for the multiple cells. Although the frequency resources will be used herein as the available resources by way of example, the resource using method and system can be applied to other methods and systems using time resources, code resources, time slot resources, space resources, and the like.

An embodiment of the present invention provides one resource using method and system for allocating the unit subchannels according to cell-specific sequences and another resource using method and system for allocating resources using a DCA scheme. In this manner, the present invention divides the available frequency band into unit subchannels, and uses resources independently for cells according to sequences, i.e. allocates the unit subchannels for resource use, and in addition, the present invention allocates the unit subchannels using the DCA scheme for resource use. Further, the present invention uses resources with use of both of the two methods: one method of using resources based on sequences and another method of using resources through the DCA scheme. As a result, the present invention can minimize the occurrence of ICI and enables efficient use of resources.

In addition, an embodiment of the present invention provides a method for dividing the entire available frequency band, divided into a predetermined number of frequency bands, into multiple unit subchannels, and allocating the unit subchannels according to sequences uniquely defined for cells. Herein, “sequence” means a resource allocation order predefined according to identifiers of multiple cells, which are determined during an initial cell design phase. Accordingly, an embodiment of the present invention provides a resource allocation method and system for allocating the unit subchannels according to predefined sequences, thereby minimizing the occurrence of ICI and maximizing efficiency of frequency resources.

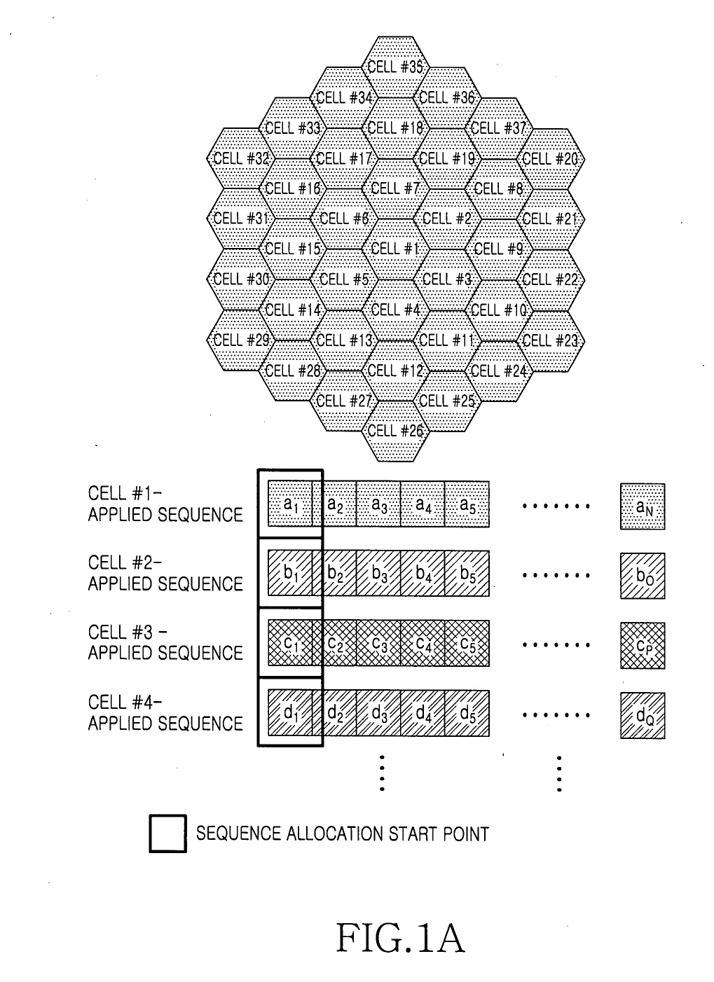

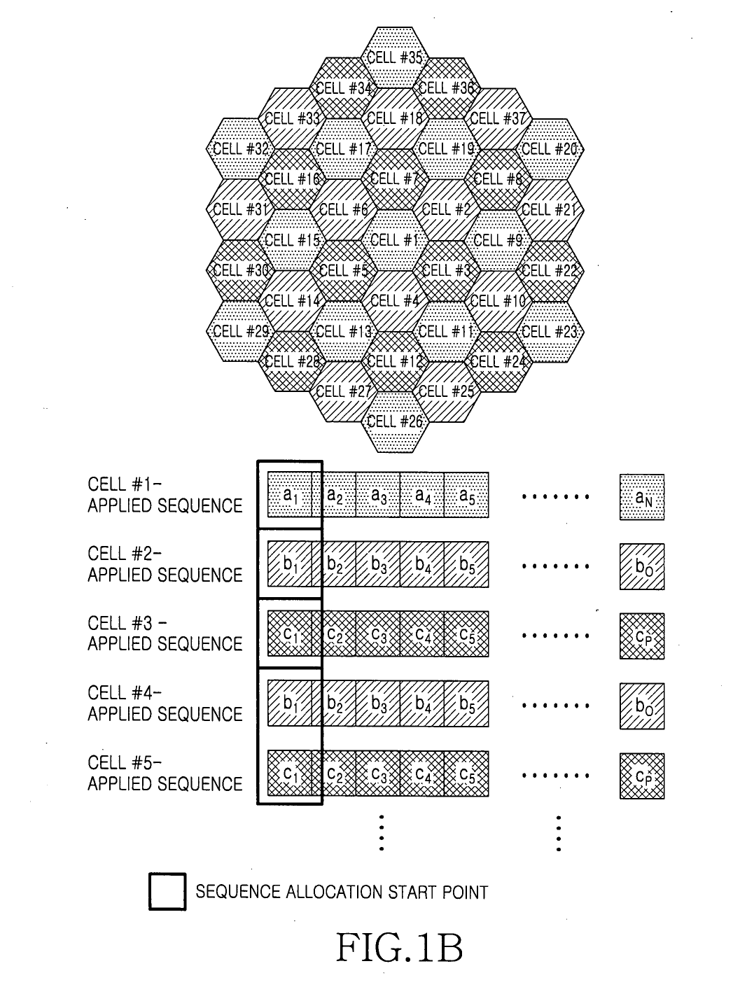

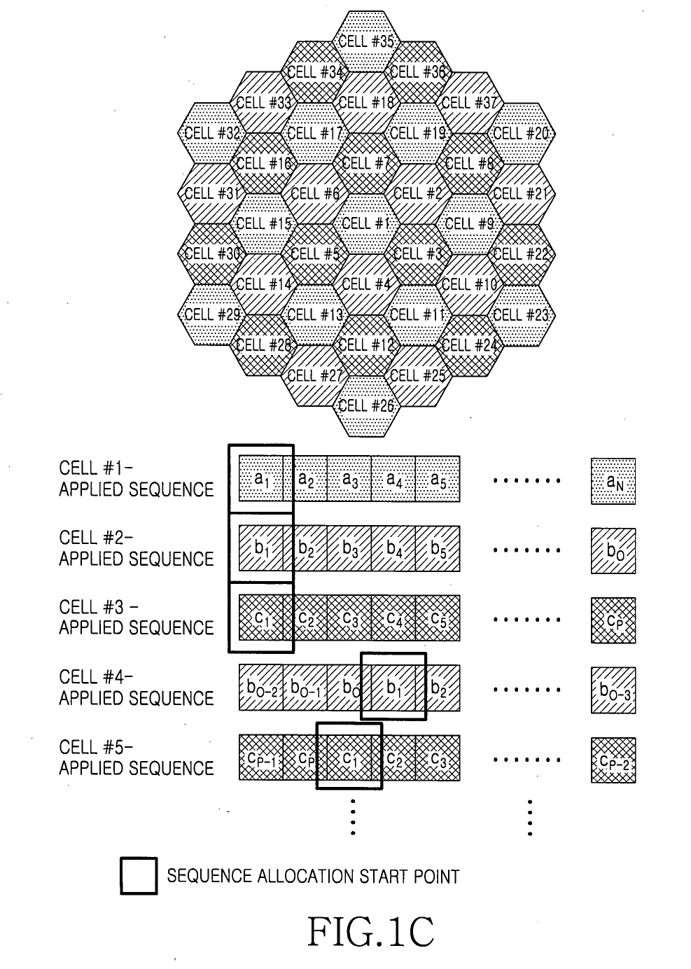

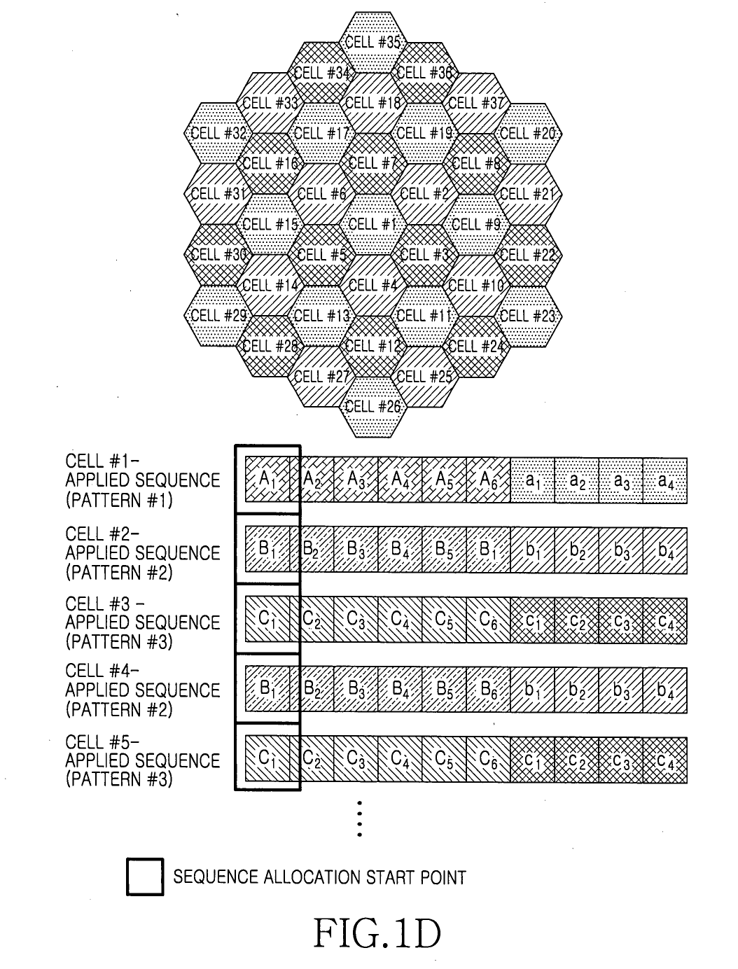

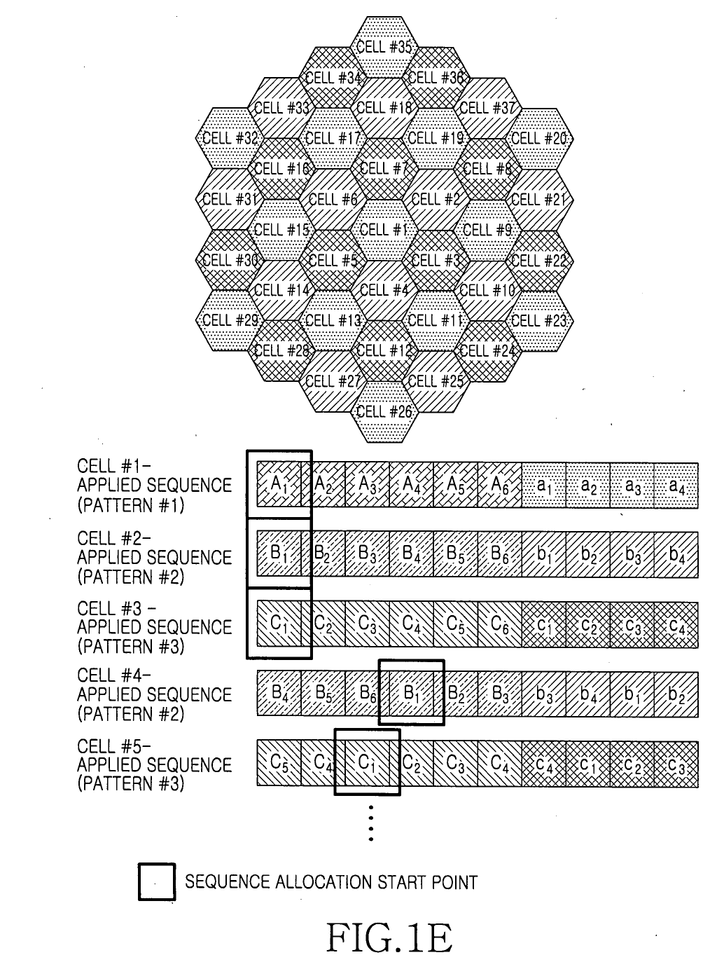

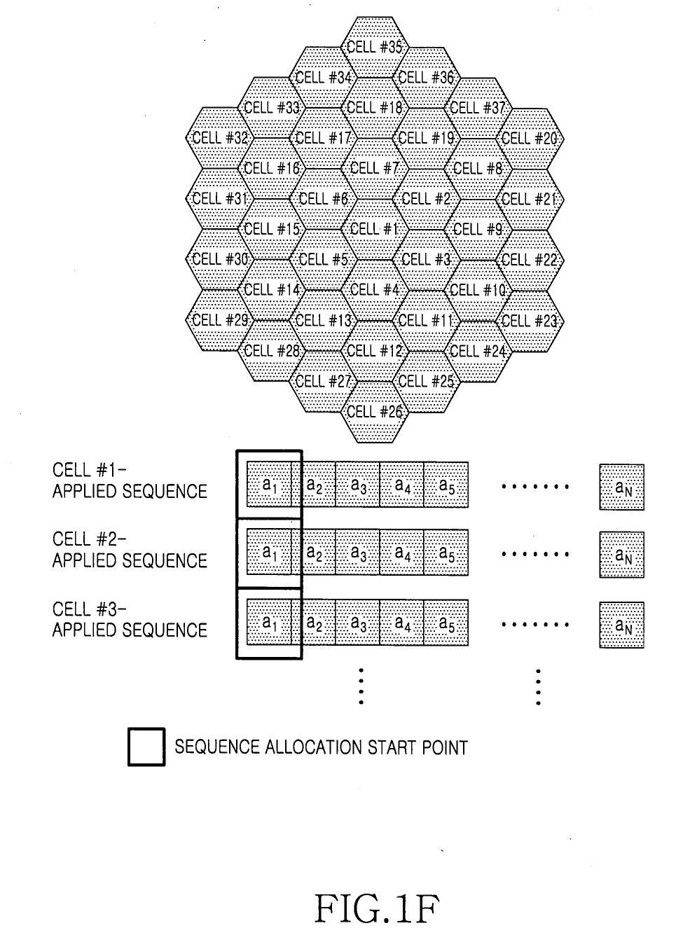

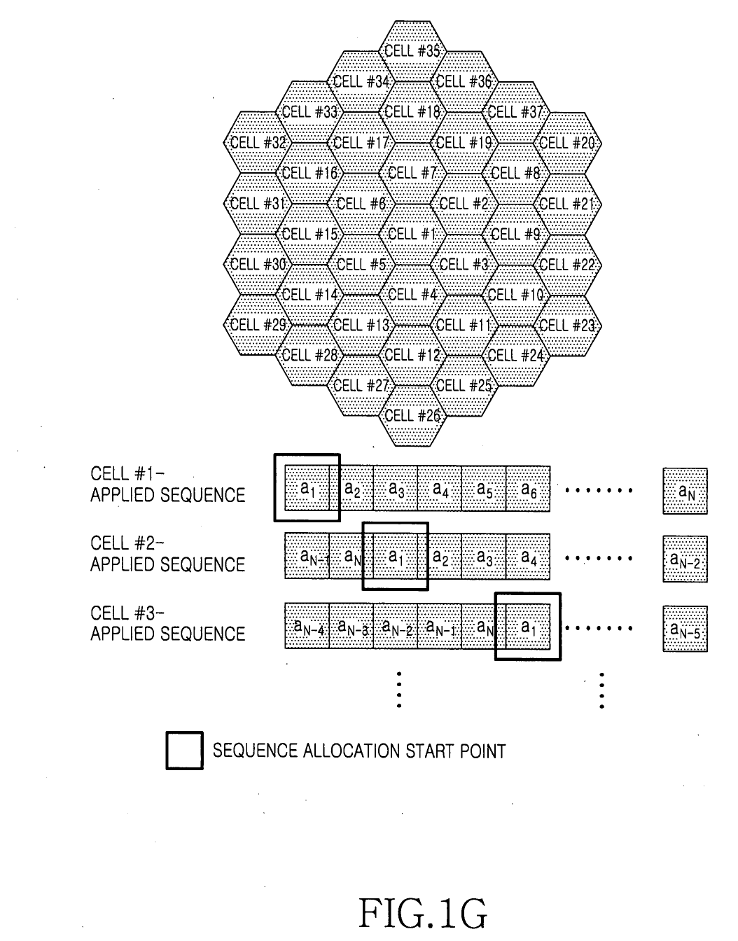

FIGS. 1A to 1G illustrate resource allocation schemes for multiple cells in a multi-cell communication system according to an embodiment of the present invention. Specifically, FIG. 1A illustrates a resource allocation scheme using different subchannel sequences in all cells. FIGS. 1B and 1C illustrate a resource allocation scheme using the same subchannel sequence in some of the multiple cells. FIGS. 1D and 1E illustrate a resource allocation scheme using the same combined subchannel allocation sequence in some cells. FIGS. 1F and 1G illustrate a resource allocation scheme using the same subchannel allocation sequences in all cells.

Referring to FIG. 1A, a multi-cell communication system having multiple cells, i.e. cell #1 to cell #37, allocates resources, i.e. subchannels, to the cells according to sequences to be applied to the cells, i.e. subchannel allocation sequences, such as a cell #1-applied sequence (meaning a sequence to be applied to cell #1), a cell #2-applied sequence, a cell #3-applied sequence, a cell #4-applied sequence, etc. Herein, the sequences to be applied to the cells are equal in sequence allocation start point, i.e. subchannel allocation start point, and are different in length. As the cell #1-applied sequence, the cell #2-applied sequence, the cell #3-applied sequence, the cell #4-applied sequence, etc. are different from each other, the multi-cell communication system allocates the subchannels to the cells using the different subchannel allocation sequences. In addition, the multi-cell communication system allocates the subchannels to the cells at different start points using the subchannel allocation sequences.

In addition, a₁, a₂, a₃, a₄, a₅, . . . , a_{N}; b₁, b₂, b₃, b₄, b₅, . . . , b_{O}; c₁, c₂, c₃, c₄, c₅, . . . , c_{P}; and d₁, d₂, d₃, d₄, d₅, . . . , d_{Q} of the cell #1-applied sequence, the cell #2-applied sequence, the cell #3-applied sequence, and the cell #4-applied sequence mean indexes of the subchannel allocation sequences for the cells. From the indexes of the subchannel allocation sequences for the cells, it can be noted that the sequences to be applied to the cells are different in length such that a length of the cell #1-applied sequence is N, a length of the cell #2-applied sequence is O, a length of the cell #3-applied sequence is P, and a length of the cell #4-applied sequence is Q. Although the sequences to be applied to the cells are different in length herein not only in FIG. 1A but also in other embodiments of the present invention, the resource allocation method and system of the present invention can be applied to the case where the sequences to be applied to the cells are equal in length.

Referring to FIG. 1B, a multi-cell communication system having multiple cells, i.e. cell #1 to cell #37, as described in FIG. 1A, allocates resources, i.e. subchannels, to the cells according to sequences to be applied to the cells, i.e. subchannel allocation sequences, such as a cell #1-applied sequence, a cell #2-applied sequence, a cell #3-applied sequence, a cell #4-applied sequence, a cell #5-applied sequence, etc. Herein, the sequences to be applied to the cells are equal in sequence allocation start point, i.e. subchannel allocation start point, and are different in length. In addition, the applied sequences for non-adjacent cells among the multiple cells are equal.

For example, the cell #1-applied sequence is equal to the applied sequences for cell #9, cell #11, cell #13, cell #15, cell #17, cell #19, cell #20, cell #23, cell #26, cell #29, cell #32, and cell #35, all of which are not adjacent to cell #1, and the cell #2-applied sequence is equal to the applied sequences for cell #4, cell #6, and cell #10. In addition, the cell #3-applied sequence is equal to the applied sequences for cell #5, cell #7, and cell #8. Accordingly, the multi-cell communication system allocates the subchannels to the adjacent cells using different subchannel allocation sequences, and allocates the subchannels to the non-adjacent cells using the same subchannel allocation sequences. Here, the multi-cell communication system allocates the subchannels to the non-adjacent cells at the same start point using the same subchannel allocation sequences.

As described above, a₁, a₂, a₃, a₄, a₅, . . . , a_{N}; b₁, b₂, b₃, b₄, b₅, . . . , b_{O}; and c₁, c₂, c₃, c₄, c₅, . . . , c_{P} of the cell #1-applied sequence, the cell #2-applied sequence, the cell #3-applied sequence, the cell #4-applied sequence, and the cell #5-applied sequence mean indexes of the subchannel allocation sequences for the cells. From the indexes of the subchannel allocation sequences for the cells, it can be noted that a length of the cell #1-applied sequence is N, a length of the cell #2-applied sequence and a length of the cell #4-applied sequence are O, and a length of the cell #3-applied sequence and a length of the cell #5-applied sequence are P.

Referring to FIG. 1C, a multi-cell communication system having multiple cells, i.e. cell #1 to cell #37, as described in FIG. 1B, allocates resources, i.e. subchannels, to the cells according to sequences to be applied to the cells, i.e. subchannel allocation sequences, such as a cell #1-applied sequence, a cell #2-applied sequence a cell #3-applied sequence, a cell #4-applied sequence, a cell #5-applied sequence, etc. Herein, the sequences to be applied to the cells are different in sequence allocation start point, i.e. subchannel allocation start point, and are different in length. In addition, the applied sequences for the non-adjacent cells among the multiple cells are equal, and the same applied sequences are different in sequence allocation start point.

For example, the cell #1-applied sequence is equal to the applied sequences for cell #9, cell #11, cell #13, cell #15, cell #17, cell #19, cell #20, cell #23, cell #26, cell #29, cell #32, and cell #35, all of which are not adjacent to cell #1, and the cell #2-applied sequence is equal to the applied sequences for cell #4, cell #6, and cell #10. In addition, the cell #3-applied sequence is equal to the applied sequences for cell #5, cell #7 and cell #8. Further, the cell #-9 applied sequence and the cell #-11 applied sequence, which are equal to the cell #1-applied sequence, are different in sequence allocation start point, and the cell #6-applied sequence, which is equal to the cell #2-applied sequence, is different in sequence allocation start point, and the cell #5-applied sequence and the cell #7-applied sequence, which are equal to the cell #3-applied sequence, are different in sequence allocation start point. Accordingly, the multi-cell communication system allocates the subchannels to the adjacent cells using the different subchannel allocation sequences, and allocates the subchannels to the non-adjacent cells using the same subchannel allocation sequences. Here, the multi-cell communication system allocates the subchannels to the non-adjacent cells at the different start points using the same subchannel allocation sequences.

As described above, a₁, a₂, a₃, a₄, a₅, . . . , a_{N}; b₁, b₂, b₃, b₄, b₅, . . . , b_{O}; and c₁, c₂, c₃, c₄, c₅, . . . , c_{P} of the cell #1-applied sequence, the cell #2-applied sequence, the cell #3-applied sequence, the cell #4-applied sequence, and the cell #5-applied sequence mean indexes of the subchannel allocation sequences for the cells. From the indexes of the subchannel allocation sequences for the cells, it can be noted that a length of the cell #1-applied sequence is N, a length of the cell #2-applied sequence and a length of the cell #4-applied sequence are O, and a length of the cell #3-applied sequence and a length of the cell #5-applied sequence are P.

Referring to FIG ID, a multi-cell communication system having multiple cells, i.e. cell #1 to cell #37, as described above, allocates resources, i.e. subchannels, to the cells according to sequences to be applied to the cells, i.e. subchannel allocation sequences, such as a cell #1-applied sequence, a cell #2-applied sequence, a cell #3-applied sequence, a cell #4-applied sequence, a cell #5-applied sequence, etc. Herein, the sequences to be applied to the cells are equal in sequence allocation start point, i.e. subchannel allocation start point. In addition, the applied sequences for the non-adjacent cells among the multiple cells are equal. As for the same applied sequences for the cells, indexes of the subchannels are combined in the same patterns, and the combined applied sequences are equal in sequence allocation start point.

For example, the cell #1-applied sequence is equal to the applied sequences for cell #9, cell #11, cell #13, cell #15, cell #17, cell #19, cell #20, cell #23, cell #26, cell #29, cell #32, and cell #35, all of which are not adjacent to the cell #1, and the cell #2-applied sequence is equal to the applied sequences for cell #4, cell #6, and cell #10. In addition, the cell #3-applied sequence is equal to the applied sequences for cell #5, cell #7, and cell #8. As for the cell #9-applied sequence and the cell #11-applied sequence, which are equal to the cell #1-applied sequence, indexes of the subchannels are combined in a pattern #1. As for the cell #4-applied sequence and the cell #6-applied sequence, which are equal to the cell #2-applied sequence, indexes of the subchannels are combined in a pattern #2. As for the cell #5-applied sequence and the cell #7-applied sequence, which are equal to the cell #3-applied sequence, indexes of the subchannels are combined in a pattern #3. As described above, the applied sequences combined in each of the patterns are equal in sequence allocation start point. Accordingly, the multi-cell communication system allocates the subchannels to the adjacent cells using the different subchannel allocation sequences, and allocates the subchannels to the non-adjacent cells using the same subchannel allocation sequences. Here, the multi-cell communication system allocates the subchannels to the non-adjacent cells at the same start points using the same subchannel allocation sequences.

As described above, A₁, A₂, A₃, A₄, A₅, A₆; B₁, B₂, B₃, B₄, B₅, B₆; and C₁, C₂, C₃, C₄, C₅, C₆ of the cell #1-applied sequence, the cell #2-applied sequence, the cell #3-applied sequence, the cell #4-applied sequence, and the cell #5-applied sequence mean indexes of the subchannel allocation sequences combined in each of the patterns. In addition, a₁, a₂, a₃, a₄; b₁, b₂, b₃, b₄; and c₁, c₂, c₃, c₄ of the cell #1-applied sequence, the cell #2-applied sequence, the cell #3-applied sequence, the cell #4-applied sequence, and the cell #5-applied sequence mean indexes of the subchannel allocation sequences for the cells. Although the multi-cell communication system uses in FIG. 1D the different subchannel allocation sequences between the adjacent cells and allocates the subchannels to the cells at the same start points, the multi-cell communication system can use the same subchannel allocation sequences for all cells, and allocate the subchannels to the cells at the same start points or different start points. That is, the multi-cell communication system uses the applied sequences combined in the same patterns for all cells, and allocates the applied sequences for the cells at the same start points or different start points.

Referring to FIG. 1E, a multi-cell communication system having multiple cells, i.e. cell #1 to cell #37, as described in FIG. 1D, allocates resources, i.e. subchannels, to the cells according to sequences to be applied to the cells, i.e. subchannel allocation sequences, such as a cell #1-applied sequence, a cell #2-applied sequence, a cell #3-applied sequence, a cell #4-applied sequence, a cell #5-applied sequence, etc. Herein, the sequences to be applied to the cells are different in sequence allocation start point, i.e. subchannel allocation start point. In addition, the applied sequences for the non-adjacent cells among the multiple cells are equal. As for the same applied sequences for the cells, indexes of the subchannels are combined in the same patterns, and the combined applied sequences are different in sequence allocation start point. That is, indexes of subchannels in the applied sequences for the cells are cyclic-shifted.

For example, the cell #1-applied sequence is equal to the applied sequences for cell #9, cell #11, cell #13, cell #15, cell #17, cell #19, cell #20, cell #23, cell #26, cell #29, cell #32, and cell #35, all of which are not adjacent to the cell #1, and the cell #2-applied sequence is equal to the applied sequences for cell #4, cell #6, and cell #10. In addition, the cell #3-applied sequence is equal to the applied sequences for cell #5, cell #7, and cell #8. As for the cell #9-applied sequence and the cell #11-applied sequence, which are equal to the cell #1-applied sequence, indexes of the subchannels are combined in a pattern #1. As for the cell #4-applied sequence and the cell #6-applied sequence, which are equal to the cell #2-applied sequence, indexes of the subchannels are combined in a pattern #2. As for the cell #5-applied sequence and the cell #7-applied sequence, which are equal to the cell #3-applied sequence, indexes of the subchannels are combined in a pattern #3. As described above, the applied sequences combined in each of the patterns are different in sequence allocation start point. Accordingly, the multi-cell communication system allocates the subchannels to the adjacent cells using the different subchannel allocation sequences, and allocates the subchannels to the non-adjacent cells using the same subchannel allocation sequences. Here, the multi-cell communication system allocates the subchannels to the non-adjacent cells at the different start points using the same subchannel allocation sequences.

As for the sequences combined from the cell #4-applied sequence and the cell #5-applied sequence, or as for the applied sequences for the cells, the pattern #2 and the pattern #3 are different in sequence allocation start point after cyclic shift. In other words, although the sequence combined from the cell #4-applied sequence in the pattern #2, i.e. the combined sequence having indexes B₁, B₂, B₃, B₄, B₅, B₆, and the sequence combined from the cell #5-applied sequence in the pattern #4, i.e. the combined sequence having indexes C₁, C₂, C₃, C₄, C₅, C₆, are different in sequence allocation start point in FIG. 1E, the cell #4-applied sequence i.e. the applied sequences having indexes b₁, b₂, b₃, b₄ can change in sequence allocation start point, and the cell #5-applied sequence, i.e. the applied sequences having indexes c₁, c₂, c₃, c₄ can change in sequence allocation start point.

As described above, A₁, A₂, A₃, A₄, A₅, A₆; B₁, B₂, B₃, B₄, B₅, B₆; and C₁, C₂, C₃, C₄, C₅, C₆ of the cell #1-applied sequence, the cell #2-applied sequence, the cell #3-applied sequence, the cell #4-applied sequence, and the cell #5-applied sequence mean indexes of the subchannels combined in each of the patterns. In addition, a₁, a₂, a₃, a₄; b₁, b₂, b₃, b₄; and c₁, c₂, c₃, c₄ of the cell #1-applied sequence, the cell #2-applied sequence, the cell #3-applied sequence, the cell #4-applied sequence, and the cell #5-applied sequence mean indexes of the subchannel allocation sequences for the cells.

Referring to FIG. 1F, a multi-cell communication system having multiple cells, i.e. cell #1 to cell #37, allocates resources, i.e. subchannels, to the cells according to sequences to be applied to the cells, i.e. subchannel allocation sequences, such as a cell #1-applied sequence, a cell #2-applied sequence, a cell #3-applied sequence, etc. Herein, the sequences to be applied to the cells are equal in sequence allocation start point, i.e. subchannel allocation start point. Because the cell #1-applied sequence, the cell #2-applied sequence, and the cell #3-applied sequence are equal, the multi-cell communication system allocates the subchannels to the cells using the same subchannel allocation sequences. In allocating the subchannels to the cells using the same subchannel allocation sequences, the multi-cell communication system allocates the subchannels at the same start points. In addition, a₁, a₂, a₃, a₄, a₅, . . . , a_{N} of the cell #1-applied sequence, the cell #2-applied sequence, and the cell #3-applied sequence mean indexes of the subchannel allocation sequence for the cells. From the indexes of the subchannel allocation sequences for the cells, it can be noted that a length of the applied sequences for the cells is N.

Referring to FIG. 1G, a multi-cell communication system having multiple cells, i.e. cell #1 to cell #37, allocates resources, i.e. subchannels, to the cells according to sequences to be applied to the cells, i.e. subchannel allocation sequences, such as a cell #1-applied sequence, a cell #2-applied sequence, a cell #3-applied sequence, etc. Herein, the sequences to be applied to the cells are different in sequence allocation start point, i.e. subchannel allocation start point. Because the cell #1-applied sequence, the cell #2-applied sequence, and the cell #3-applied sequence are equal, the multi-cell communication system allocates the subchannels to the cells using the same subchannel allocation sequences. In allocating the subchannels to the cells using the same subchannel allocation sequences, the multi-cell communication system allocates the subchannels at the different start points. In addition, a₁, a₂, a₃, a₄, a₅, . . . , a_{N} of the cell #1-applied sequence, the cell #2-applied sequence, and the cell #3-applied sequence mean indexes of the subchannel allocation sequence for the cells.

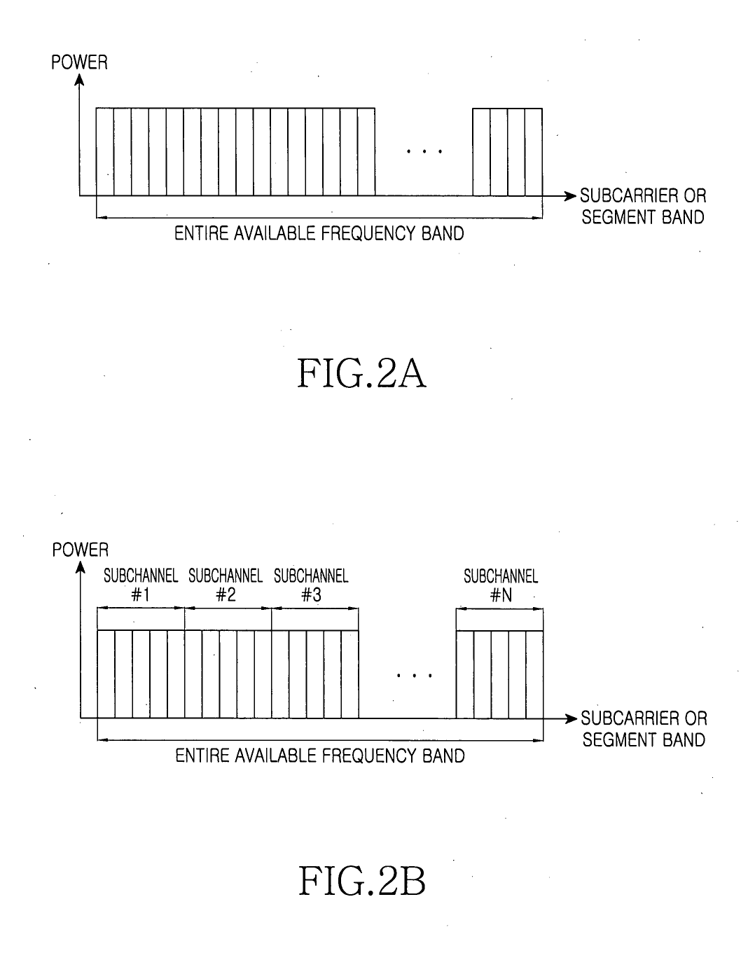

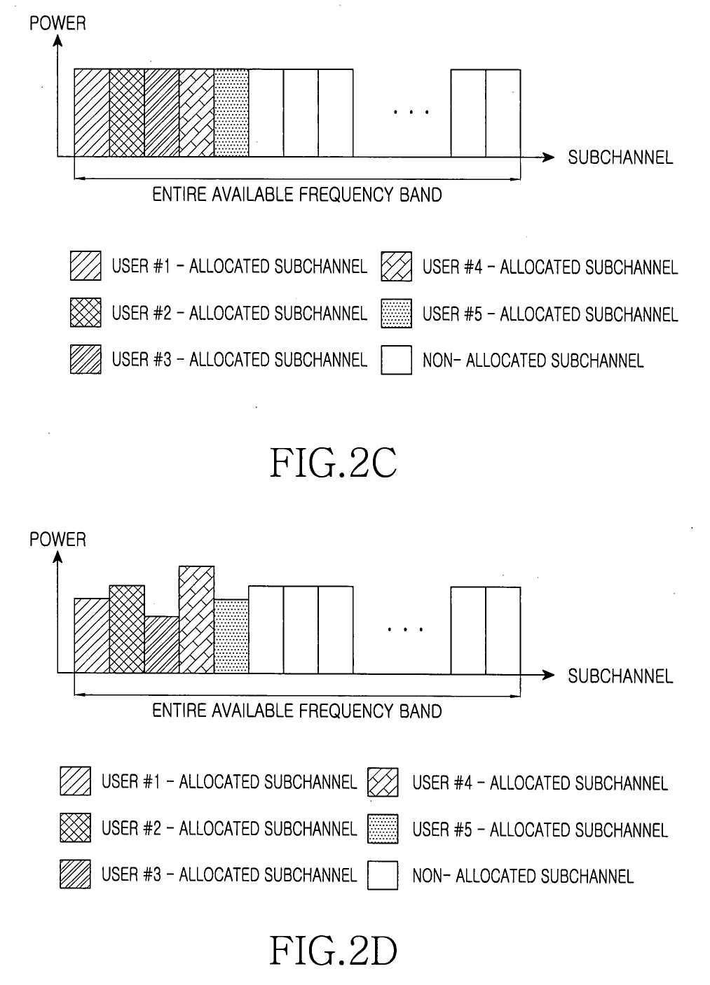

FIGS. 2A to 2D illustrate resource allocation methods in which a multi-cell communication system allocates resources in units of subchannels in the entire available frequency band according to an embodiment of the present invention. Specifically, FIG. 2A illustrates a structure of the entire frequency band available by a multi-cell communication system. FIG. 2B illustrates a structure in which the entire available frequency band shown in FIG. 2A is divided into subchannels. FIG. 2C illustrates a structure in which the subchannels shown in FIG. 2B are allocated to users existing in multiple cells. FIG. 2D illustrates a structure in which power control is performed in units of subchannels allocated to the users, shown in FIG. 2C.

Referring to FIG. 2A, the entire frequency band available in all cells by a multi-cell communication system in a multi-cell environment, i.e. the entire available frequency band, is divided into successive subcarriers or segment bands. Herein, the communication system divides the entire available frequency band into several hundreds or thousands of narrow bands for resource allocation, and one narrow band is a subcarrier or segment band.

Referring to FIG. 2B, a predetermined number of subcarriers or segment bands in the entire available frequency band shown in FIG. 2A constitute a unit subchannel. That is, the unit subchannel is a basic unit in which resources are allocated to users existing in multiple cells, and as it is composed of a predetermined number of subcarriers or segment bands, when all subchannels, i.e. a first subchannel to an N^{th} subchannel, are allocated, a size of the allocated subchannels is equal to that of the entire available frequency band.

Referring to FIG. 2C, the multi-cell communication system allocates resources in units of subchannels each composed of a predetermined number of subcarriers or segment bands, and users existing in the cells are allocated resources in units of subchannels as described above.

Referring to FIG. 2D, the multi-cell communication system can control power in units of subchannels, which are allocated to the users existing in the cells as shown in FIG. 2C, and can control power in units of subcarriers or segment bands constituting the unit subchannel. The power control in units of subchannels is not directly related to the present invention, so a detailed description thereof will be omitted herein.

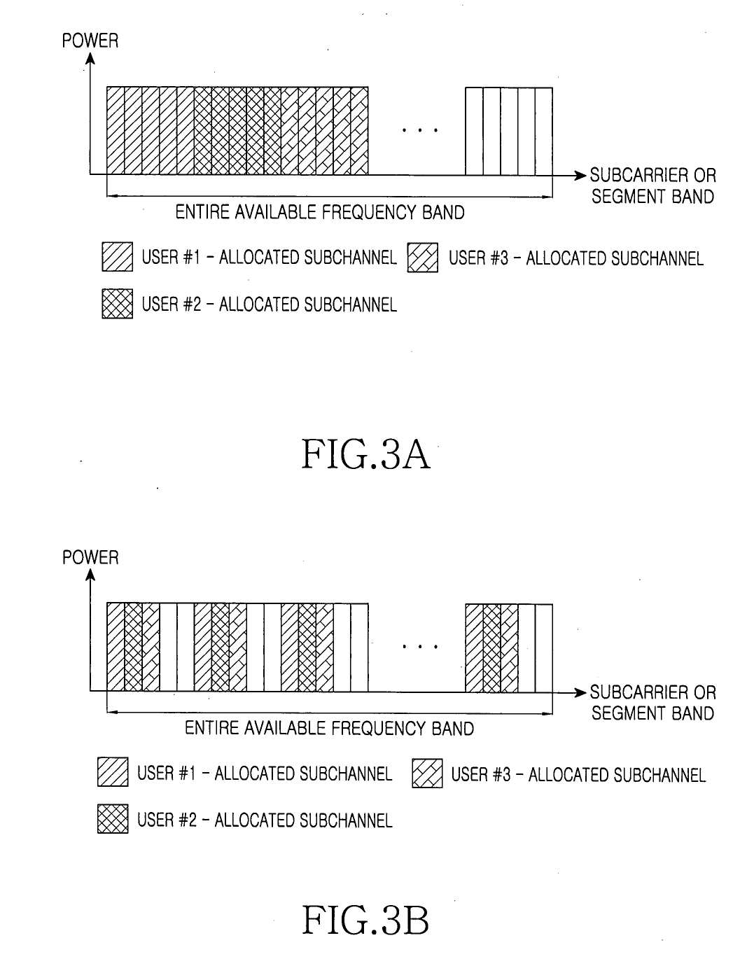

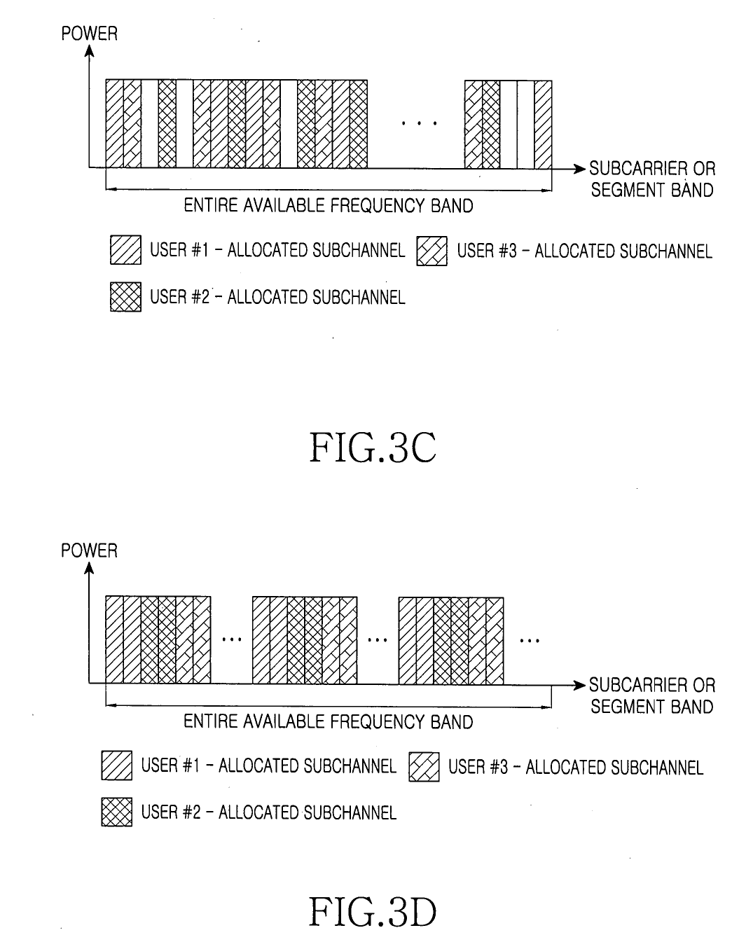

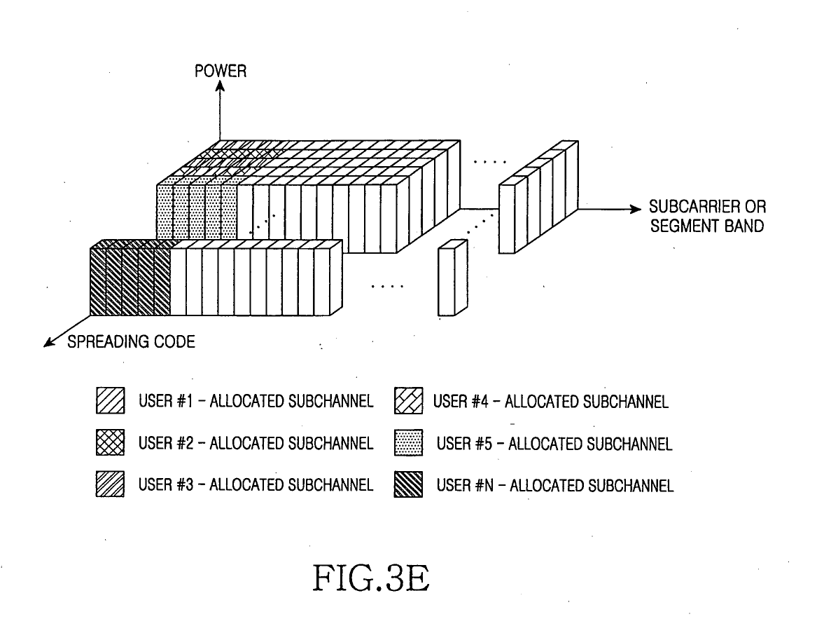

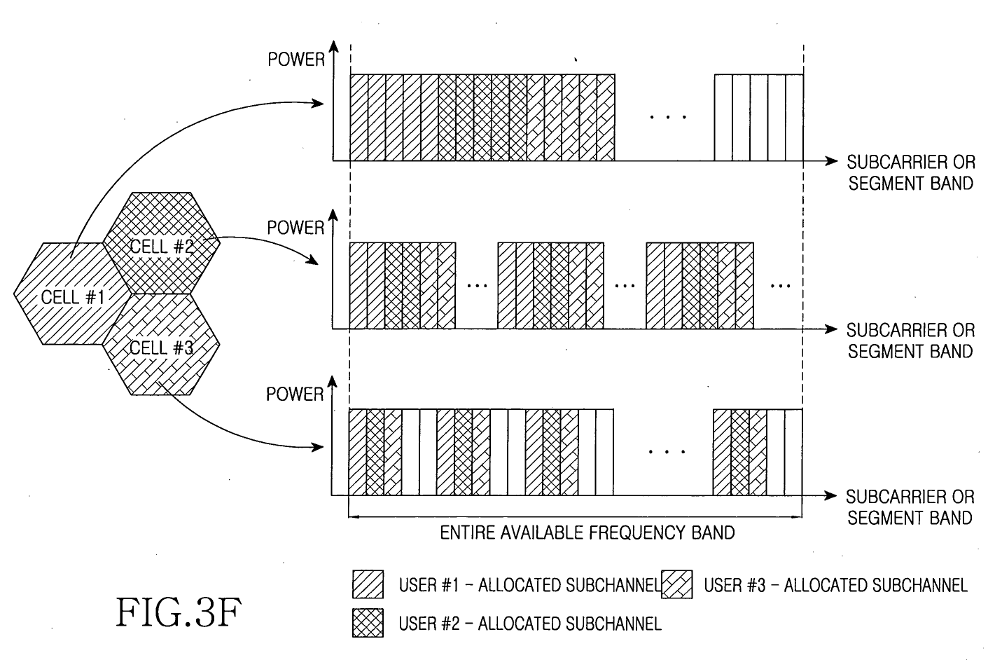

FIGS. 3A to 3F illustrate configuration schemes for subchannels in a multi-cell communication system according to an embodiment of the present invention. Specifically, FIG. 3A illustrates a scheme of configuring subchannels in a band type. FIG. 3B illustrates a scheme of configuring subchannels in a regularly distributed type. FIG. 3C illustrates a scheme of configuring subchannels in an irregularly distributed type. FIG. 3D illustrates a scheme of configuring subchannels in a mixed type. FIG. 3E illustrates a scheme of configuring subchannels in an extended shared type. FIG. 3F illustrates a scheme of configuring subchannels in a cell-specific type.

Referring to FIG. 3A, in the band-type subchannel configuration scheme, the multi-cell communication system configures one subchannel with a predetermined number of, for example, N consecutive subcarriers or segment bands in the entire available frequency band. That is, the multi-cell communication system allocates unit subchannels each composed of N consecutive subcarriers or segment bands, to users existing in the multiple cells.

Referring to FIG. 3B, in, the regularly distributed-type subchannel configuration scheme, the multi-cell communication, system configures one subchannel with N subcarriers or segment bands regularly distributed in the entire available frequency band. That is, the multi-cell communication system allocates unit subchannels each composed of N subcarriers or segment bands regularly distributed in the entire available frequency band, to users existing in the multiple cells.

Referring to FIG. 3C, in the irregularly distributed-type subchannel configuration scheme, the multi-cell communication system configures one subchannel with N subcarriers or segment bands irregularly distributed in the entire available frequency band. That is, the multi-cell communication system allocates unit subchannels each composed of N subcarriers or segment bands irregularly distributed in the entire available frequency band, to users existing in the multiple cells.

Referring to FIG. 3D, in the mixed-type subchannel configuration scheme, i.e. in the mixed scheme of the band-type scheme of FIG. 3A and the regularly distributed-type scheme of FIG. 3B, the multi-cell communication system groups N consecutive subcarriers or segment bands in the entire available frequency band in the band type, and then distributes the subcarrier groups or segment band groups over the entire available frequency band in the regularly distributed type. That is, the multi-cell communication system allocates unit subchannels each composed of subcarrier groups or segment band groups distributed over the entire available frequency band in the regularly distributed type, to users existing in the multiple cells.

Referring to FIG. 3E, in the extended shared-type subchannel configuration scheme, the multi-cell communication system configures one subchannel in such a manner that multiple subchannels share physically consecutive or distributed subcarrier groups or segment band groups using logically dividable codes, i.e. spreading codes. That is, the multi-cell communication system allocates, to users existing in the multiple cells, N unit subchannels each composed of consecutive or distributed subcarrier groups or segment band groups shared using the spreading codes in the entire available frequency band.

Referring to FIG. 3F, in the cell-specific type subchannel configuration scheme, the multi-cell communication system allocates resources to cells by applying the same subchannel configuration schemes to all cells, allocates resources to cells by applying the different subchannel configuration schemes to all cells, or allocates resources to cells by applying the same/different subchannel configuration schemes to some cells. In the last case where the resources are allocated to cells by applying the same/different subchannel configuration schemes to some cells, the multi-cell communication system configures subchannels by applying the different subchannel configuration schemes to non-adjacent cells among all cells, and configures subchannels by applying the same subchannel configuration schemes to the other cells. For convenience, in the scheme shown in FIG. 3, the multi-cell communication system allocates resources to cells by applying the different subchannel configuration schemes to cell #1, cell #2, and cell #3. As described above, the multi-cell communication system can allocate resources to cells by (i) applying the different subchannel configuration schemes to all the three cells, (ii) applying the same subchannel configuration schemes to all the three cells, or (iii) applying the same subchannel configuration schemes to two cells and applying the different subchannel configuration scheme to the other one cell.

More specifically, for cell #1, the multi-cell communication system configures unit subchannels in the band type shown in FIG. 3A, and allocates the unit subchannels to users existing in cell #1. For cell #2, the multi-cell communication system configures unit subchannels in the mixed type shown in FIG. 3D, and allocates the unit subchannels to users existing in cell #2. For cell #3, the multi-cell communication system configures unit subchannels in the regularly distributed type shown in FIG. 3B, and allocates the unit subchannels to users existing in cell #3.

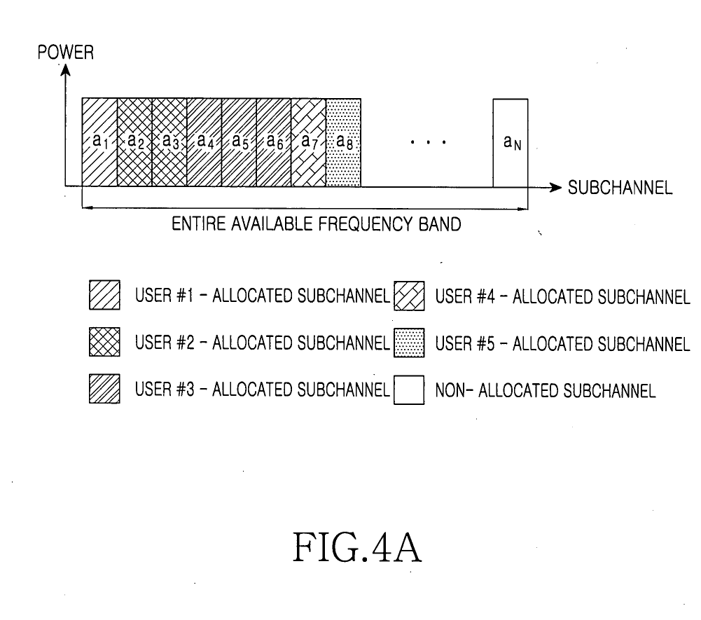

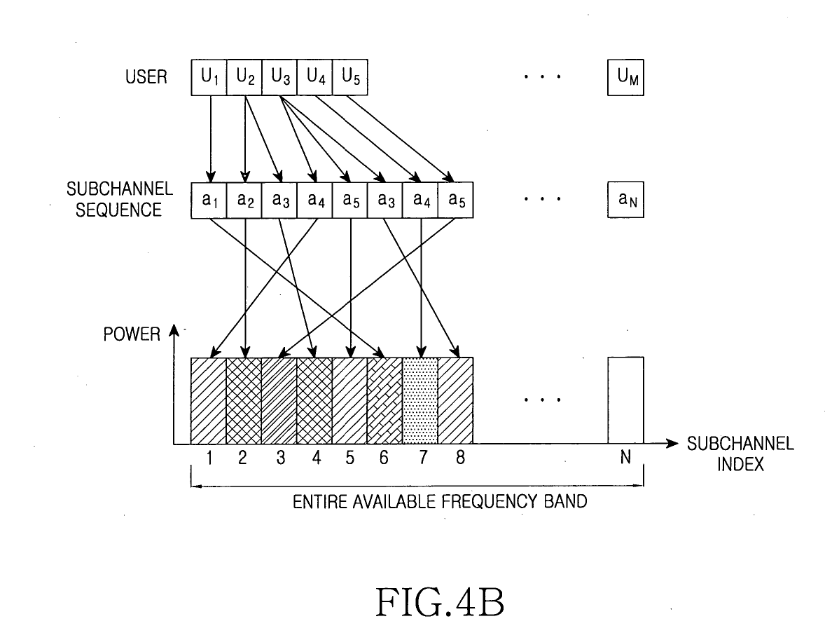

FIGS. 4A and 4B illustrate schemes in which a multi-cell communication system allocates resources to users existing in the multiple cells according to an embodiment of the present invention. Specifically, FIG. 4A illustrates a method in which unit subchannels configured in the entire available frequency band are allocated to users. FIG. 4B illustrates a process in which the unit subchannels are allocated to users.

Referring to FIG. 4A, a multi-cell communication system configures unit subchannels in the entire frequency band using the foregoing schemes, and allocates the unit subchannels to users existing in the cells. Here, the multi-cell communication system allocates the unit subchannels to the users according to a sequence, in such a manner that at least one unit subchannel is allocated to each of the users according to the sequence indexes. For example, as shown in FIG. 4A, one unit subchannel is allocated to a user #1, two unit subchannels are allocated to a user #2, three unit subchannels are allocated to a user #3, and one unit subchannel is allocated to each of a user #4 and a user #5. In this case, the subchannels are allocated to the users using a subchannel sequence having sequence indexes of a₁, a₂, a₃, a₄, a₅, a₆, a₇, a₈, . . . , a_{N}. This subchannel allocation method allocates subchannels according to the subchannel sequences in response to a resource allocation request from users, and more than one unit subchannel is allocated to each of the users in response to the resource allocation request in the foregoing manner. If a length of the sequence is N, like the sequence indexes, the number of unit subchannels divided from the entire available frequency band is also N. Accordingly, the sequence indexes are mapped to the unit subchannels on a one to one basis. That is, the subchannel sequence is used in units of unit subchannels.

Referring to FIG. 4B, in resource allocation to users existing in cells, resources are allocated in a regular sequence to users existing in the cells according to subchannel allocation sequences uniquely defined for the cells as described above. For example, if the number of users existing in one cell is M and a subchannel allocation sequence having sequence indexes of a₁, a₂, a₃, a₄, a₅, . . . , a_{N} is defined as shown in FIG. 4B, a multi-cell communication system allocates unit subchannels corresponding to the sequence indexes in the entire available frequency band to the users in a regular sequence.

More specifically, a first user U₁ is allocated a unit subchannel #6 corresponding to its associated sequence index a₁ in the subchannel allocation sequence. A second user U₂ is allocated a unit subchannel #2 and a unit subchannel #4 corresponding to its associated sequence indexes a₂ and a₃ in the subchannel allocation sequence. A third user U₃ is allocated a unit subchannel #1, a unit subchannel #5, and a unit subchannel #8 corresponding to its associated sequence indexes a₄, a₅ and a₃. A fourth user U₄ is allocated a unit subchannel #7 corresponding to its associated sequence index a₄, and a fifth user U₅ is allocated a unit subchannel #3 corresponding to its associated sequence index a₅. That is, because the sequence indexes correspond to the unit subchannels, the unit subchannels are allocated to an arbitrary user in association with the sequence indexes associated with the user, and the number of unit subchannels allocated to the user is equal to the number of sequence indexes associated with the user.

In this manner, the multi-cell communication system of the present invention allocates unit subchannels in the entire available frequency band in association with sequence indexes of subchannel sequences corresponding to the users existing in the cell using the subchannel sequences predefined as sequences to be applied to the cells as described above, thereby allocating the unit subchannels to the users in a regular sequence. In this case, as described above, the users each are allocated more than one unit subchannel according to subchannel sequences in response to their resource allocation request. If there is a new user in the cell, the multi-cell communication system allocates the next subchannel indexes of the predefined subchannel sequence to the new user, thereby allocating unit subchannels to the new user according to the next subchannel indexes.

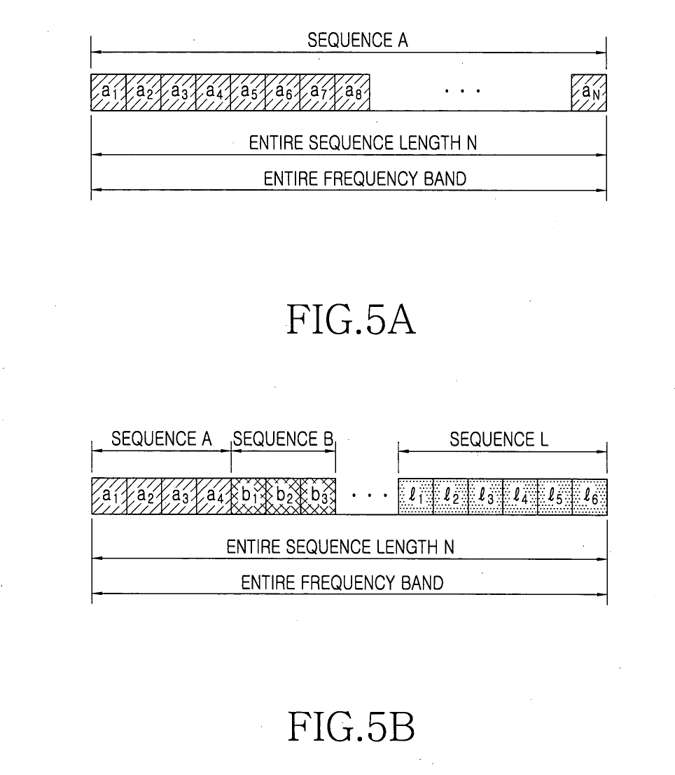

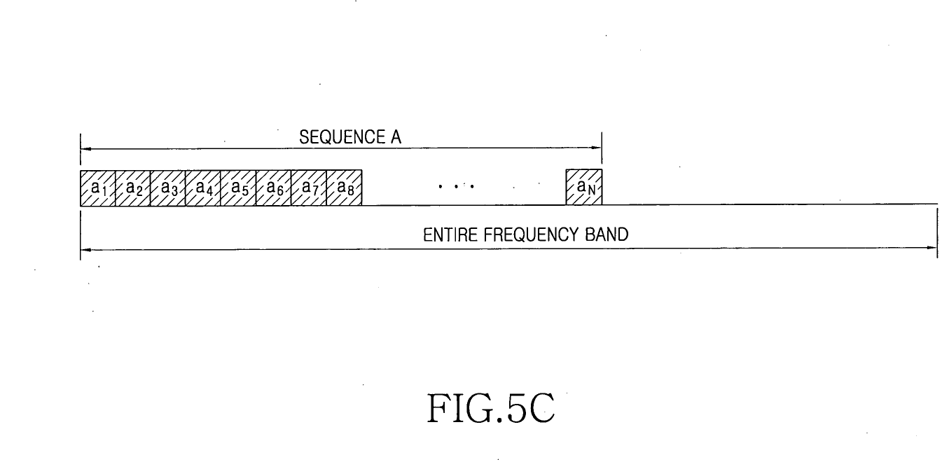

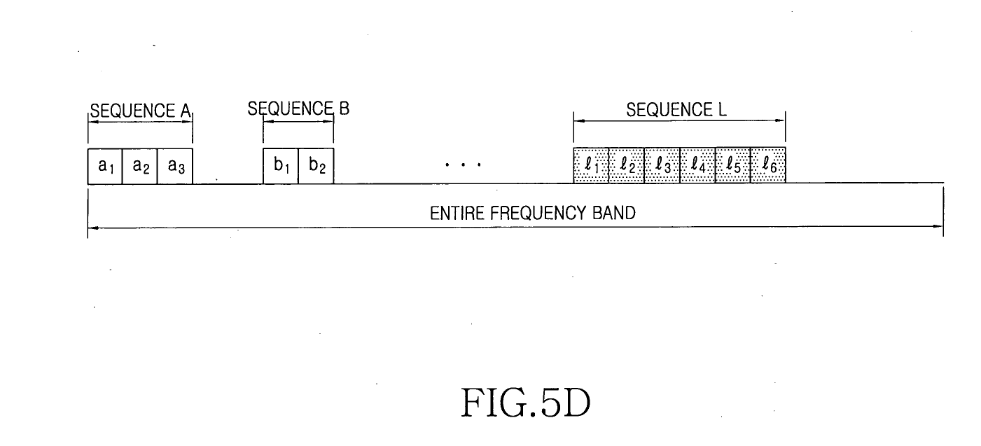

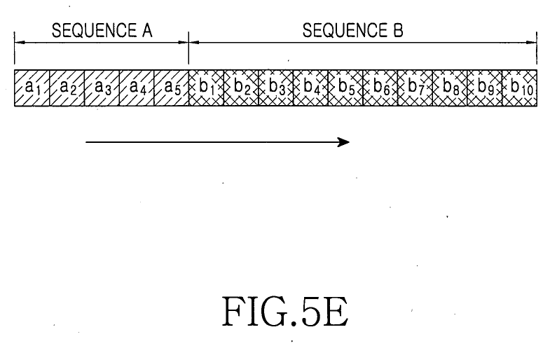

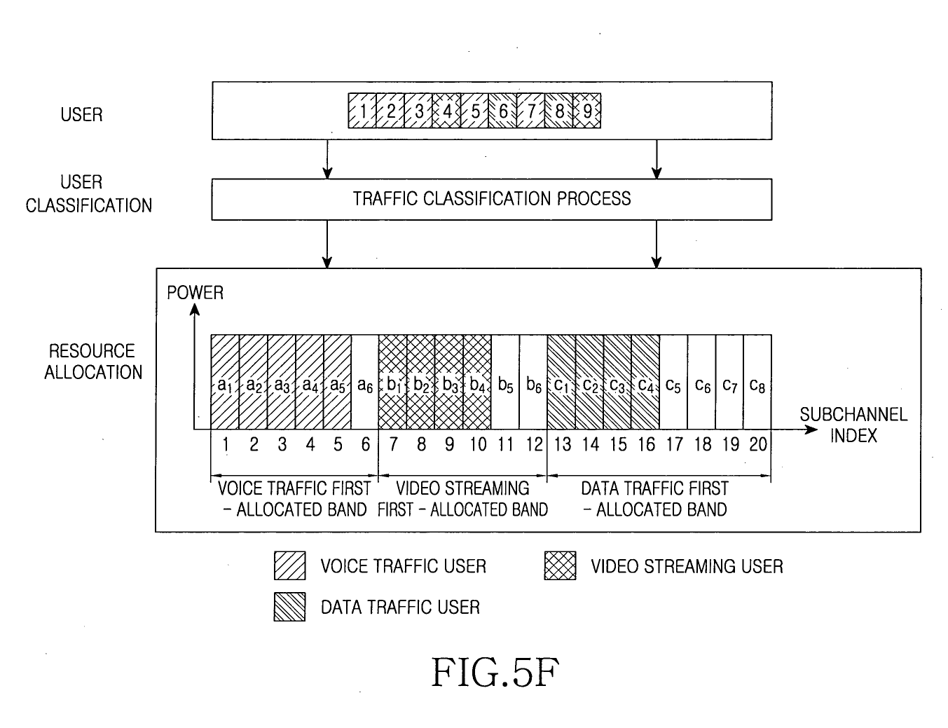

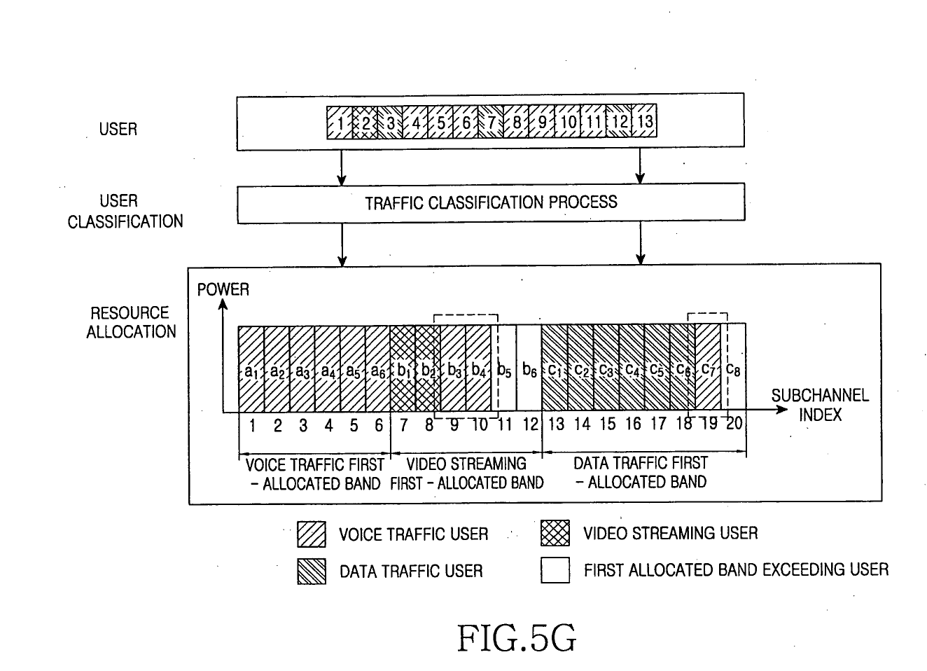

FIGS. 5A to 5G illustrate structures of sequences predefined for subchannel allocation in a multi-cell communication system according to an embodiment of the present invention. Specifically, FIG. 5A illustrates a sequence structure having the same length as that of the entire frequency band. FIG. 5B illustrates a sequence structure, which is configured by combining several sequences such that its length is equal to that of the entire frequency band. FIG. 5C illustrates a sequence structure having a length being equivalent to a part of the entire frequency band. FIG. 5D illustrates a sequence structure, which is configured by combining several sequences such that its length corresponds to a part of the entire frequency band. FIG. 5E illustrates a sequence structure for the case where resources are allocated to users in a regular sequence. FIGS. 5F and 5G illustrate sequence structures for the case where resources are allocated according to data type of users.

Referring to FIG. 5A, if the entire frequency band with length N is divided into N unit subchannels, sequence indexes a₁, a₂, a₃, a₄, a₅, a₆, a₇, a₈, . . . , a_{N} of a sequence A with total length N are mapped to the N unit subchannels, respectively. That is, the total sequence length is equivalent to the number of the unit subchannel divided from the entire frequency band.

Referring to FIG. 5B, a subchannel sequence corresponding to N unit subchannels in the entire frequency band can be configured by combining several sequences whose sequence length is shorter than N, such that the total length of the combined sequences is equivalent to the number of unit subchannels in the entire frequency band. For example, a length=4 sequence A with sequence indexes a₁, a₂, a₃, a₄ and a length=3 sequence B with sequence indexes b₁, b₂, b₃ are combined with a length=6 sequence L with sequence indexes l₁, l₂, l₃, l₄, l₅, l₆, such that the total length of the combined sequences is N and the indexes of the combined sequences are mapped to the N unit subchannels, respectively. The multi-cell communication system first allocates, to the users existing in the cell, 4 unit subchannels mapped to the indexes of the sequence A according to the sequence A, then allocates 3 unit subchannels mapped to the indexes of the sequence B according to the sequence B, and finally allocates 6 unit subchannels mapped to the indexes of the sequence L according to the sequence L.

Referring to FIG. 5C, after defining a sequence A having a length being equivalent to the number of unit subchannels allocated in a partial band of the entire frequency band, a multi-cell communication system allocates the unit subchannels allocated in the partial band according to the defined sequence A. That is, sequence indexes a₁, a₂, a₃, a₄, a₅, a₆, a₇, a₈, . . . , a_{N} of the sequence A with total length N are mapped to N unit subchannels, respectively, and the multi-cell communication system allocates the N unit subchannels mapped to the indexes of the sequence A to the users according to the sequence A in a regular sequence.

Referring to FIG. 5D, a subchannel sequence corresponding to N unit subchannels in a partial band of the entire frequency band is configured by combining several short sequences whose sequence length is shorter than N, such that the total length of the combined sequences is equivalent to the number of the unit subchannels allocated in the partial band of the entire frequency band. For example, a length=3 sequence A with sequence indexes a₁, a₂, a₃ and a length=2 sequence B with sequence indexes b₁, b₂ are combined with a length=5 sequence L with sequence indexes l₁, l₂, l₃, l₄, l₅, such that the total length of the combined sequences is N and the indexes of the combined sequences are mapped to the N unit subchannels, respectively. The multi-cell communication system first allocates, to the users existing in the cell, 3 unit subchannels mapped to the indexes of the sequence A according to the sequence A, then allocates 2 unit subchannels mapped to the indexes of the sequence B according to the sequence B, and finally allocates 5 unit subchannels mapped to the indexes of the sequence L according to the sequence L.

Referring to FIG. 5E, when resources are allocated to users in regular order according to the sequences as described above, unit subchannels are allocated according to a subchannel allocation order corresponding to the total sequence defined by combining, for example, a sequence A with sequence indexes a₁, a₂, a₃, a₄, a₅ and a sequence B with sequence indexes b₁, b₂, b₃, b₄, b₅, b₆, b₇, b₈, b₉, b₁₀. In this case, additional allocation of unit subchannels due to an increase in the loading ratio is performed from sequence A to sequence B in a regular order. This unit subchannel allocation is used when there is no need for subchannel discrimination because the unit subchannels are equal in traffic characteristics.

Referring to FIG. 5F, a subchannel sequence corresponding to N unit subchannels in the entire frequency band is configured by combining several short sequences whose sequence length is shorter than N, such that the total length of the combined sequences is equivalent to the number of the unit subchannels in the entire frequency band. Thereafter, the short sequences are independently used according to the usage of users, for example, according to traffic type. More specifically, if 20 unit subchannels are allocated in the entire available frequency band, the entire sequence having a length being equivalent to the number of the unit subchannels is configured by combining a length=6 sequence A, a length=6 sequence B, and a length=8 sequence C. Herein, a₁, a₂, a₃, a₄, a₅, a₆ mean sequence indexes of the sequence A, b₁, b₂, b₃, b₄, b₅, b₆ mean sequence indexes of the sequence B, and c₁, c₂, c₃, c₄, c₅, c₆, c₇, c₈ mean sequence indexes of the sequence C. Although the short sequences are independently used according to the usage of users, for example, according to traffic type in the foregoing description of an embodiment of the present invention, the short sequences can be independently used according to the usage of various users and communication systems, for example, according to Channel Quality Information (CQI) of the users, separately for a low-CQI user group and a high-CQI user group. In addition, the short sequences can be independently used according to service class provided to the users. The service class is not directly related to the present invention, so a detailed description thereof will be omitted herein.

When unit subchannels are allocated to users #1, #2, #3, #5 and #7 using voice traffic, users #4 and #9 using video streaming, and users #6 and #8 using data traffic, the users are classified according to traffic type. Of the classified users, the users #1, #2, #3, #5 and #7 using voice traffic are allocated unit subchannels #1, #2, #3, #4 and #5 corresponding to the sequence indexes of the sequence A according to the sequence A, the users #4 and #9 using video streaming are allocated unit subchannels #7, #8, #9 and #10 corresponding to the sequence indexes of the sequence B according to the sequence B, and the users #6 and #8 using data traffic are allocated unit subchannels #13, #14, #15 and #16 corresponding to the sequence indexes of the sequence C according to the sequence C. That is, the users are allocated the unit subchannels corresponding to the sequence indexes according to the sequences predefined separately for traffic types.

Although the users using voice traffic are allocated the unit subchannels according to the sequence A, the users using video streaming are allocated the unit subchannels according to the sequence B, and the users using data traffic are allocated the unit subchannels according to the sequence C in the foregoing description, the independent sequences combined for allocating unit subchannels according to traffic type allocate the unit subchannels according to a sequence defined during multi-cell design. In addition, when several unit subchannels are simultaneously needed to transmit one traffic, the subchannel allocation sequence used for the unit subchannel allocation is configured in the way of allocating the unit subchannels. For example, when one traffic desires to be allocated two unit subchannels, the traffic is allocated one unit subchannel according to the predefined subchannel allocation sequence, and then allocated the other one unit subchannel. In addition, a length of the sequences defined separately for the traffic types should be equal to or less than the number of unit subchannels divided from the entire frequency band.

Referring to FIG. 5G, a subchannel sequence corresponding to N unit subchannels in the entire frequency band is configured as described in FIG. 5F by combining several short sequences whose sequence length is shorter than N, such that the total length of the combined sequences is equivalent to the number of the unit subchannels in the entire frequency band. Thereafter, the short sequences are independently used according to usage of users, for example, according to traffic type. More specifically, if 20 unit subchannels are allocated in the entire available frequency band, the entire sequence having a length being equivalent to the number of the unit subchannels is configured by combining a length=6 sequence A, a length=6 sequence B, and a length=8 sequence C. Herein, a₁, a₂, a₃, a₄, a₅, a₆ mean sequence indexes of the sequence A, b₁, b₂, b₃, b₄, b₅, b₆ mean sequence indexes of the sequence B, and c₁, c₂, c₃, c₄, c₅, c₆, c₇, c₈ mean sequence indexes of the sequence C.

When unit subchannels are allocated to users #1, #4, #5, #6, #8, #9, #10, #11 and #13 using voice traffic, a user #2 using video streaming, and users #3, #7 and #12 using data traffic, the users are classified according to traffic type. Of the classified users, the users #1, #4, #5, #6, #8, #9, #10, #11 and #13 using voice traffic are allocated unit subchannels #1, #2, #3, #4, #5 and #6 corresponding to the sequence indexes of the sequence A according to the sequence A, the user #2 using video streaming is allocated unit subchannels #7 and #8 corresponding to the sequence indexes of the sequence B according to the sequence B, and the users #3, #7 and #12 using data traffic are allocated unit subchannels #13, #14, #15, #16 and #17 corresponding to the sequence indexes of the sequence C according to the sequence C. Herein, as the unit subchannels that the users #1, #4, #5, #6, #8, #9, #10, #11 and #13 using voice traffic desire to be allocated exceeds in number the unit subchannels corresponding to the indexes of the sequence A, the unit subchannels #9 and #10 not allocated to the user #2 using video streaming and the unit subchannel #19 not allocated to the users #3, #6 and #8 using data traffic are allocated to the users. When the unit subchannels corresponding to the indexes of the sequence are allocated to the users for the individual traffic types according to the sequences predefined separately for the traffic types, and if the number of users using an arbitrary one traffic increases, unit subchannels corresponding to the indexes of the sequence predefined for the traffic, other than the arbitrary one traffic, having a less number of users can be allocated. Accordingly, the resources can be efficiently used by allowing the other unit subchannels exceeding the previously allocated unit subchannels to be used.

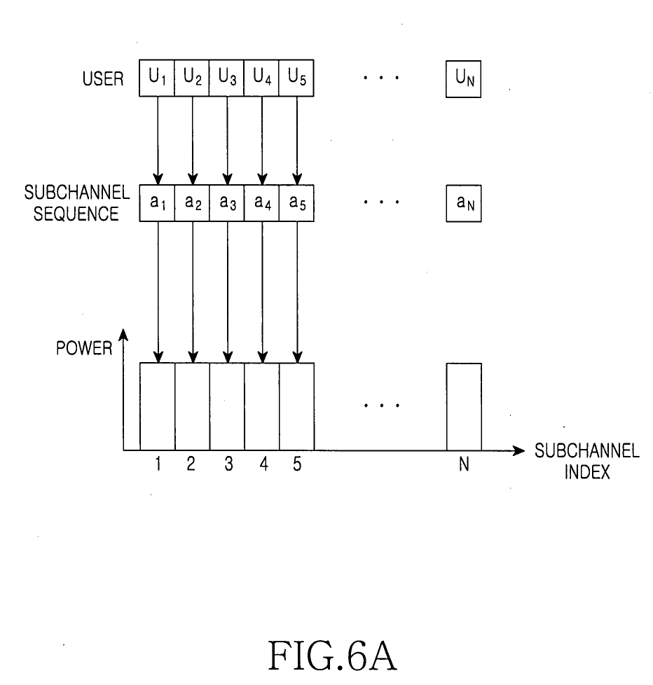

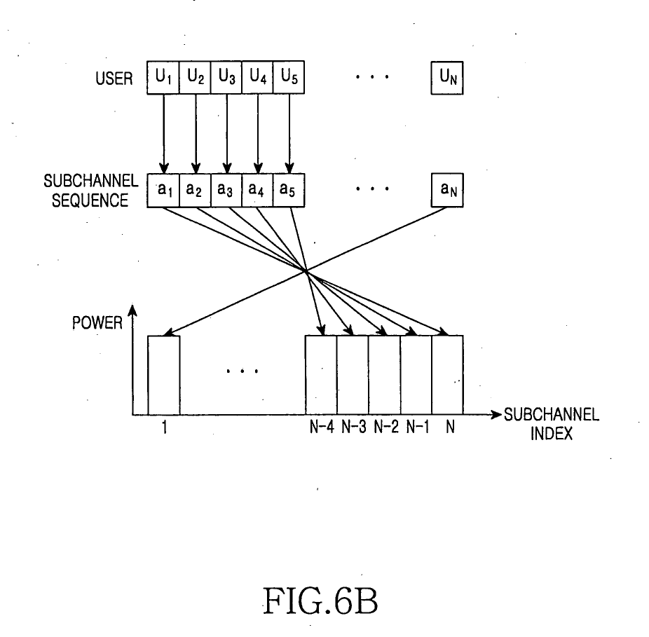

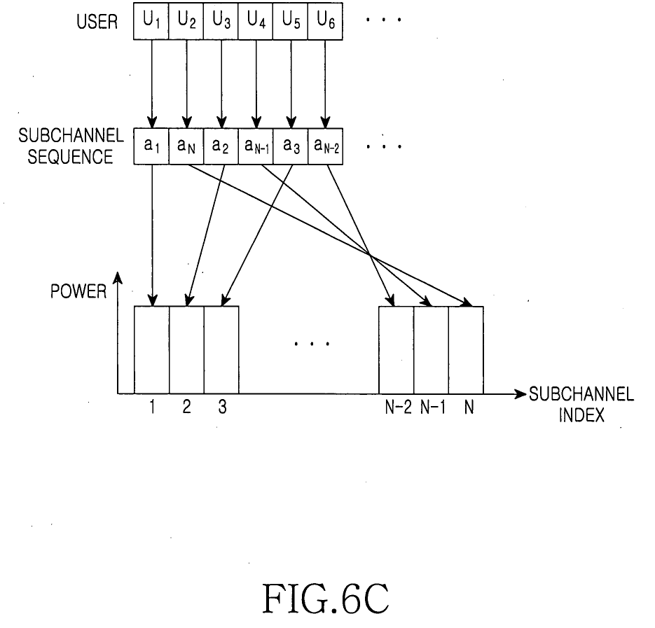

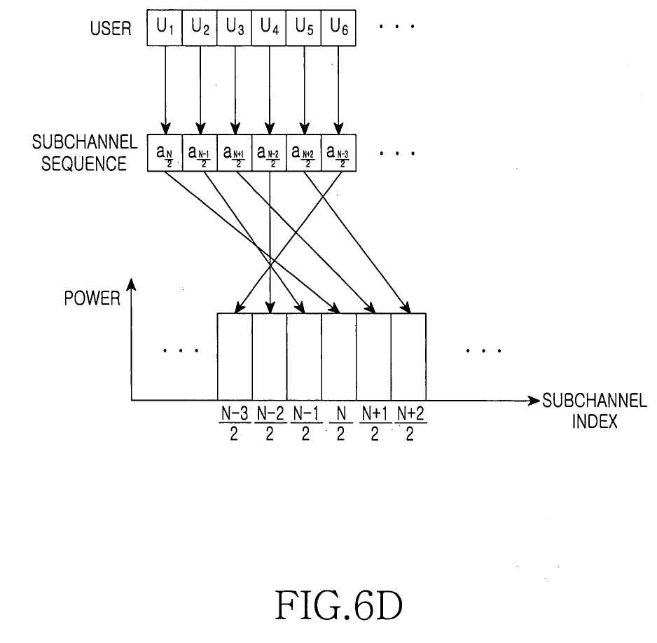

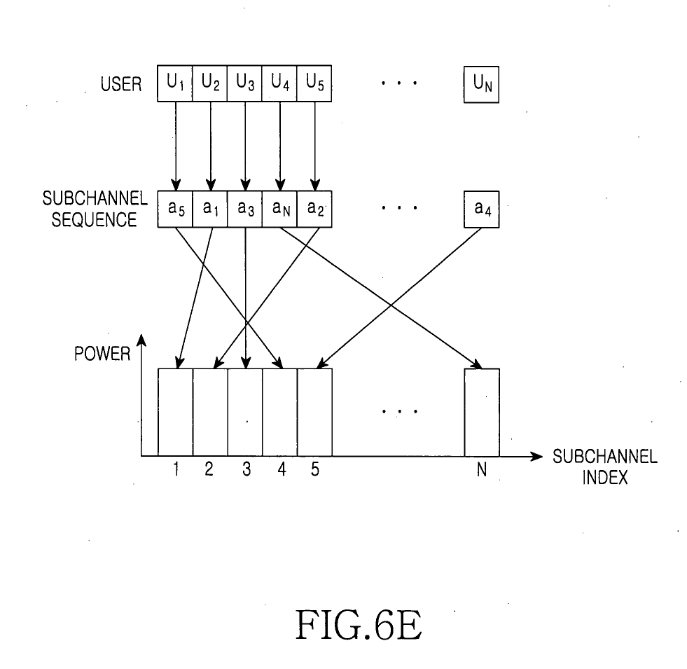

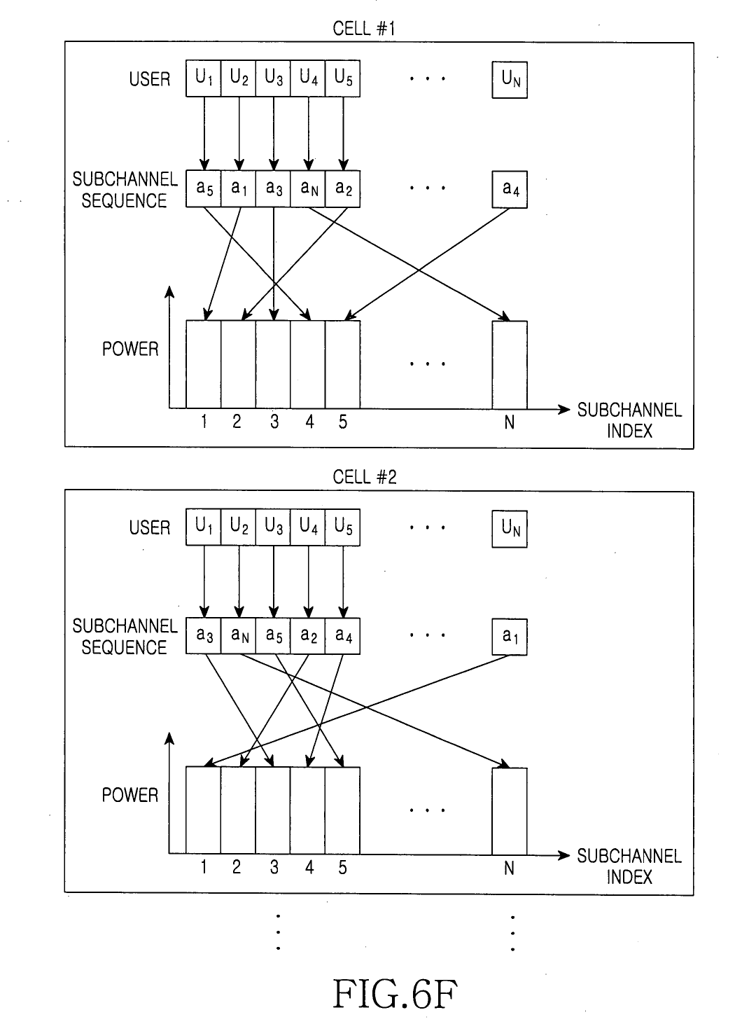

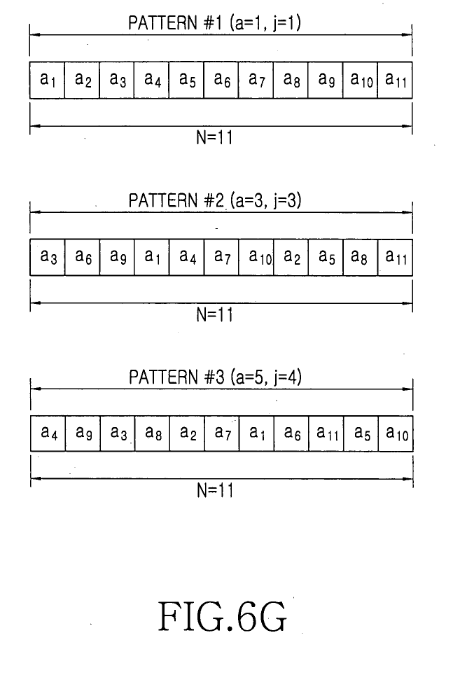

FIGS. 6A to 6G illustrate schemes in which a multi-cell communication system allocates unit subchannels depending on type of subchannel allocation sequences according to an embodiment of the present invention. Specifically, FIG. 6A illustrates a scheme of allocating unit subchannels according to a forward subchannel allocation sequence. FIG. 6B, as opposed to FIG. 6A, illustrates a scheme of allocating unit subchannels according to a reverse subchannel allocation sequence. FIG. 6C illustrates a scheme of allocating unit subchannels according to an edge-direction subchannel allocation sequence. FIG. 6D, as opposed to FIG. 6C, illustrates a scheme of allocating unit subchannels according to a center-direction subchannel allocation sequence. FIG. 6E illustrates a scheme in which all cells allocate unit subchannels according to the same pseudo random subchannel allocation sequences. FIG. 6F illustrates a scheme of allocating unit subchannels according to different pseudo random subchannel allocation sequences for the individual cells. FIG. 6G illustrates a scheme of allocating unit subchannels according to a subchannel allocation sequence defined as a specific code, for example, Latin-square code. In addition, a length of the subchannel allocation sequences is equivalent to the number of unit subchannels divided from the entire available frequency band. For convenience, in the following description of an embodiment of the present invention, a user is allocated only one unit subchannel. Therefore, it will be assumed herein that the length of the subchannel allocation sequences, the number of unit subchannels, and the number of users allocated the unit subchannels are all equal to each other.

Referring to FIG. 6A, a forward subchannel allocation sequence allocates unit subchannels to users by sequentially increasing logical indexes of the unit subchannels corresponding to indexes of the sequence. For example, if the number of unit subchannels divided from the entire available frequency band is N, an index of a unit subchannel corresponding to a sequence index a₁ is 1, and an index of a unit subchannel corresponding to a sequence index a₂ is 2. Herein, a₁, a₂, a₃, a₄, a₅, . . . , a_{N} mean indexes of the forward subchannel allocation sequence. That is, an index of a unit subchannel first allocated according to the forward subchannel allocation sequence, in other words, an index of a unit subchannel corresponding to the sequence index a₁ is 1, and an index of the last allocated unit subchannel, in other words, an index of a unit subchannel corresponding to the sequence index a_{N} is N. Accordingly, users U₁, U₂, U₃, U₄, U₅, . . . , U_{N} are allocated unit subchannels corresponding to indexes of the sequence according to the forward subchannel allocation sequence. Here, the length of the forward subchannel allocation sequence is equivalent to the number of unit subchannels allocated in the entire available frequency band.

Referring to FIG. 6B, a reverse subchannel allocation sequence, as opposed to the forward subchannel allocation sequence of FIG. 6A, allocates unit subchannels to users by sequentially decreasing logical indexes of the unit subchannels corresponding to indexes of the sequence. For example, if the number of unit subchannels divided from the entire available frequency band is N, an index of a unit subchannel corresponding to a sequence index a₁ is N, and an index of a unit subchannel corresponding to a sequence index a₂ is N−1. Herein, a₁, a₂, a₃, a₄, a₅, . . . , a_{N} mean indexes of the reverse subchannel allocation sequence. That is, an index of a unit subchannel first allocated according to the reverse subchannel allocation sequence, in other words, an index of a unit subchannel corresponding to the sequence index a₁ is N, and an index of the last allocated unit subchannel, in other words, an index of a unit subchannel corresponding to the sequence index a_{N} is 1. Accordingly, users U₁, U₂, U₃, U₄, U₅, . . . , U_{N} are allocated unit subchannels corresponding to indexes of the sequence according to the reverse subchannel allocation sequence. Here, the length of the reverse subchannel allocation sequence is equivalent to the number of unit subchannels allocated in the entire available frequency band.

Referring to FIG. 6C, an edge-direction subchannel allocation sequence allocates unit subchannels to users in the way of allocating logical indexes of the unit subchannels corresponding to the sequence from unit subchannel indexes at both edges, i.e. unit subchannel indexes 1 and N, to the central unit subchannel index, i.e. unit subchannel index N/2. For example, if the number of unit subchannels divided from the entire available frequency band is N, an index of a unit subchannel corresponding to a sequence index a₁ is 1, and an index of a unit subchannel corresponding to a sequence indexes a₂ is 2. Herein, a₁, a_{N}, a₂, a_{N-1}, a₃, a_{N-2}, mean indexes of the edge-direction subchannel allocation sequence. That is, an index of a unit subchannel first allocated according to the edge-direction subchannel allocation sequence, in other words, an index of a unit subchannel corresponding to the sequence index a₁ is 1, and an index of the last allocated unit subchannel, in other words, an index of a unit subchannel corresponding to the sequence index a_{N/2} is N/2. Accordingly, users U₁, U₂, U₃, U₄, U₅, . . . , U_{N} are allocated unit subchannels corresponding to indexes of the sequence according to the edge-direction subchannel allocation sequence. Here, the length of the edge-direction subchannel allocation sequence is equivalent to the number of unit subchannels allocated in the entire available frequency band.

Referring to FIG. 6D, a center-direction subchannel allocation sequence allocates unit subchannels to users in the way of allocating logical indexes of the unit subchannels corresponding to the sequence from the central unit subchannel index, i.e. unit subchannel index N/2, to unit subchannel indexes at both edges, i.e. unit subchannel indexes 1 and N. Herein, a_{N/2}, a_{N-1/2}, a_{N+1/2}, a_{N-2/2}, a_{N+2/2}, a_{N-3/2}, . . . , a_{N} mean indexes of the center-direction subchannel allocation sequence. That is, an index of a unit subchannel first allocated according to the center-direction subchannel allocation sequence, in other words, an index of a unit subchannel corresponding to the sequence index a_{N/2} is N/2, and an index of the last allocated unit subchannel, in other words, an index of a unit subchannel corresponding to the sequence index a_{N} is N. Accordingly, users U₁, U₂, U₃, U₄, U₅, . . . , U_{N} are allocated unit subchannels corresponding to indexes of the sequence according to the center-direction subchannel allocation sequence. Here, the length of the center-direction subchannel allocation sequence is equivalent to the number of unit subchannels allocated in the entire available frequency band.

Referring to FIG. 6E, in a scheme in which all cells allocate unit subchannels according to the same pseudo random subchannel allocation sequences, all cells allocate unit subchannels corresponding to indexes of the sequence according to a predefined random sequence. Herein, a₅, a₁, a₃, a_{N}, a₂, . . . , a₄ mean indexes of the pseudo random subchannel allocation sequence. Accordingly, users U₁, U₂, U₃, U₄, U₅, . . . , U_{N} are allocated unit subchannels corresponding to indexes of the sequence according to the pseudo random subchannel allocation sequence. Here, the length of the pseudo random subchannel allocation sequence is equivalent to the number of unit subchannels allocated in the entire available frequency band.

Referring to FIG. 6F, a scheme of allocating unit subchannels according to different pseudo random subchannel allocation sequences for the individual cells allocates unit subchannels corresponding to indexes of the sequence separately for the individual cells according to a predefined random sequence. Herein, a₅, a₁, a₃, a_{N}, a₂, . . . , a₄ mean indexes of a pseudo random subchannel allocation sequence for a first cell, and a₃, a_{N}, a₅, a₂, a₄, . . . , a₁ mean indexes of a pseudo random subchannel allocation sequence for a second cell. Accordingly, users U₁, U₂, U₃, U₄, U₅, . . . , U_{N} existing in the first cell and the second cell are allocated unit subchannels corresponding to indexes of the sequences according to the pseudo random subchannel allocation sequences. Here, the length of the pseudo random subchannel allocation sequences is equivalent to the number of unit subchannels allocated in the entire available frequency band.

Referring to FIG. 6G, a subchannel allocation sequence defined as a Latin-square code allocates Latin-square codes having different slopes for individual cells. The Latin-square code can be expressed as shown in Equation (1).
{a}ᵢⱼ={ai+j}modN (1)

In Equation (1), i={0,1, . . . ,N−1}, j={0,1, . . . ,N−1}, and N denotes the number of unit subchannels allocated in the entire available frequency band. If the number of unit subchannels is 11, a₁, a₂, a₃, a₄, a₅, a₆, a₇, a₈, a₉, a₁₀, a₁₁ mean indexes of a subchannel allocation sequence defined as a Latin-square code in a pattern #1 (a=1, j=1), a₃, a₆, a₉, a₁, a₄, a₇, a₁₀, a₂, a₅, a₈, a₁₁ mean indexes of a subchannel allocation sequence defined as a Latin-square code in a pattern #2 (a=3, j=3), and a₄, a₉, a₃, a₈, a₂, a₇, a₁, a₆, a₁₁, a₅, a₁₀ mean indexes of a subchannel allocation sequence defined as a Latin-square code in a pattern #3 (a=5, j=4). Although a Latin-square code is used herein as a specific code of the subchannel allocation sequence, other various specific codes can also be used for allocating unit subchannels corresponding to indexes of the subchannel allocation sequence to the users. Here, the length of the pseudo random subchannel allocation sequence is equivalent to the number of unit subchannels allocated in the entire available frequency band.

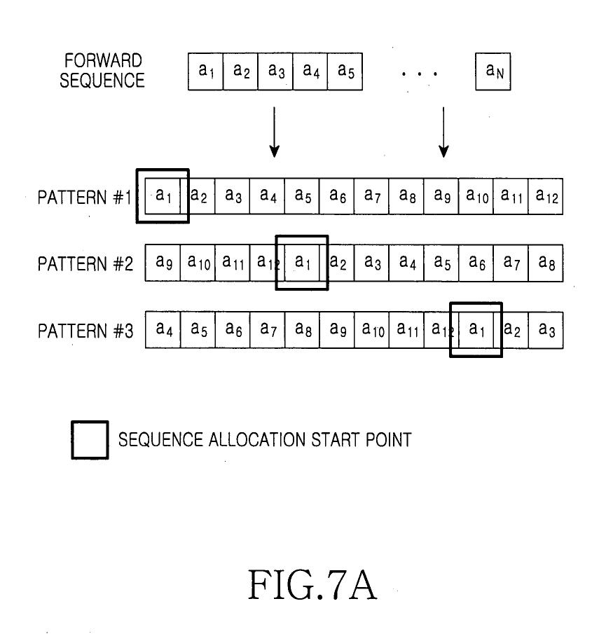

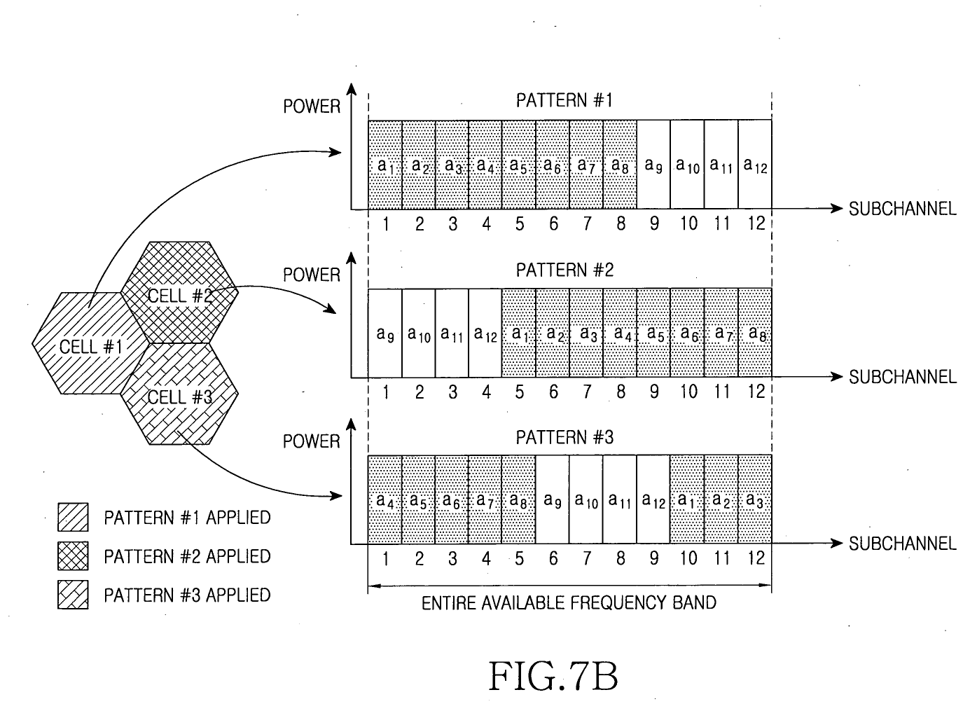

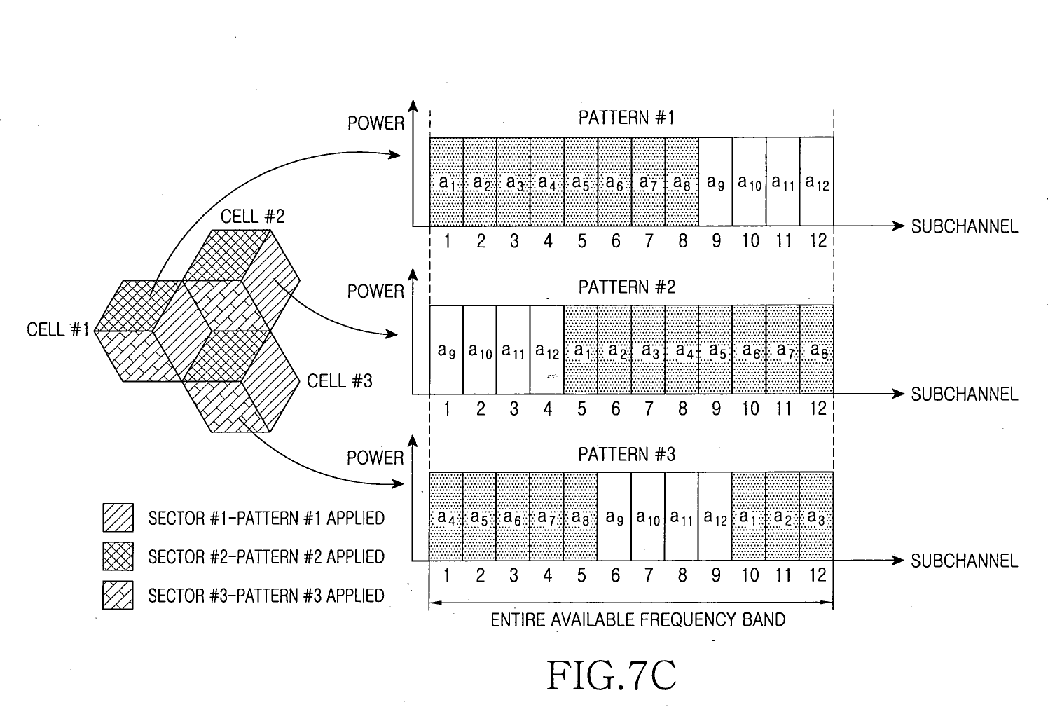

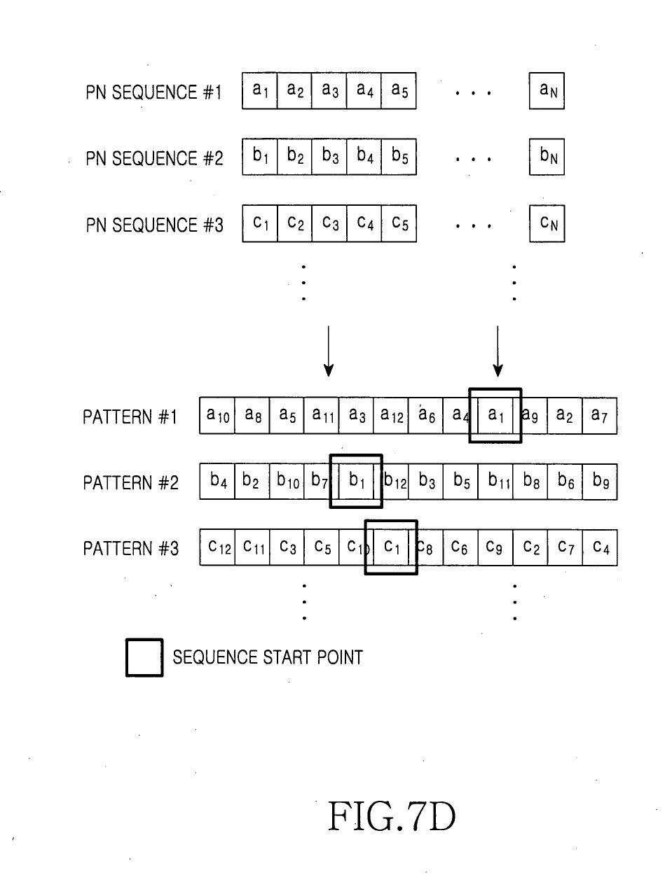

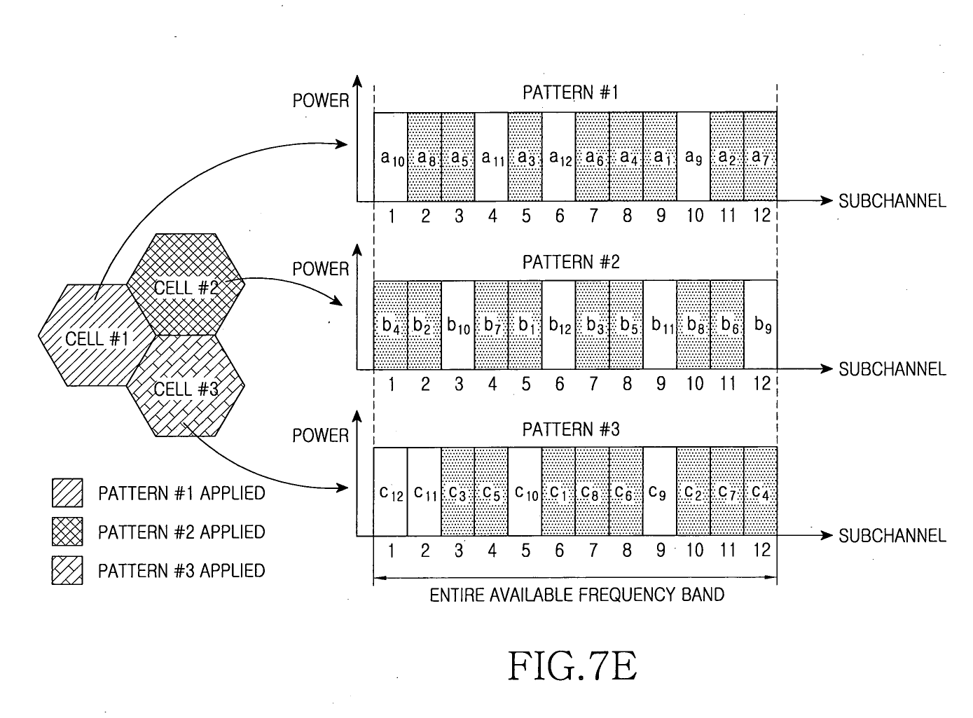

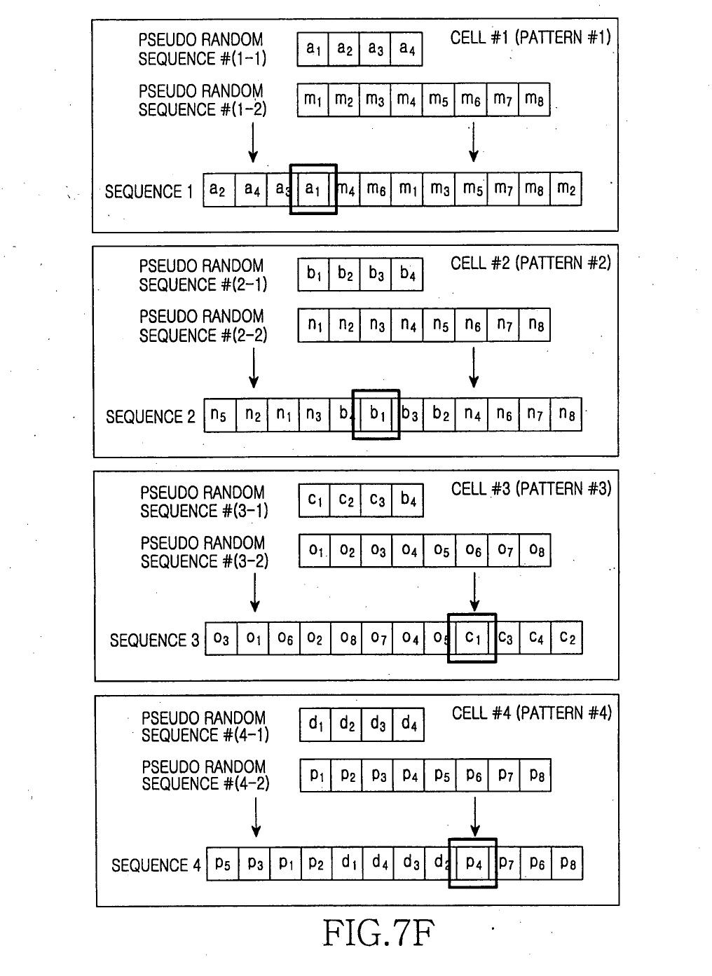

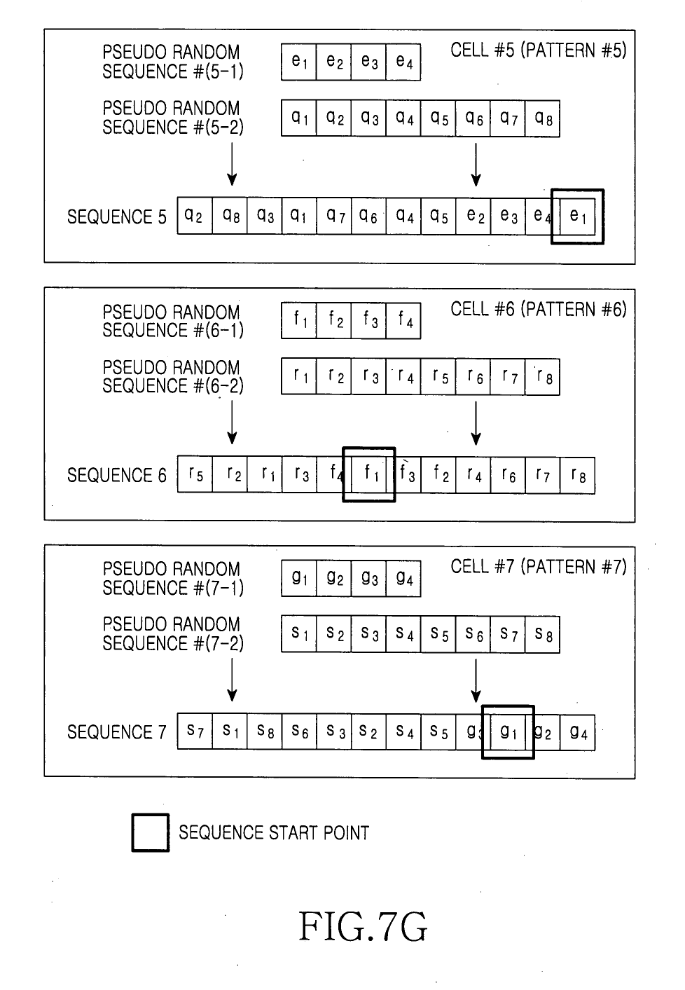

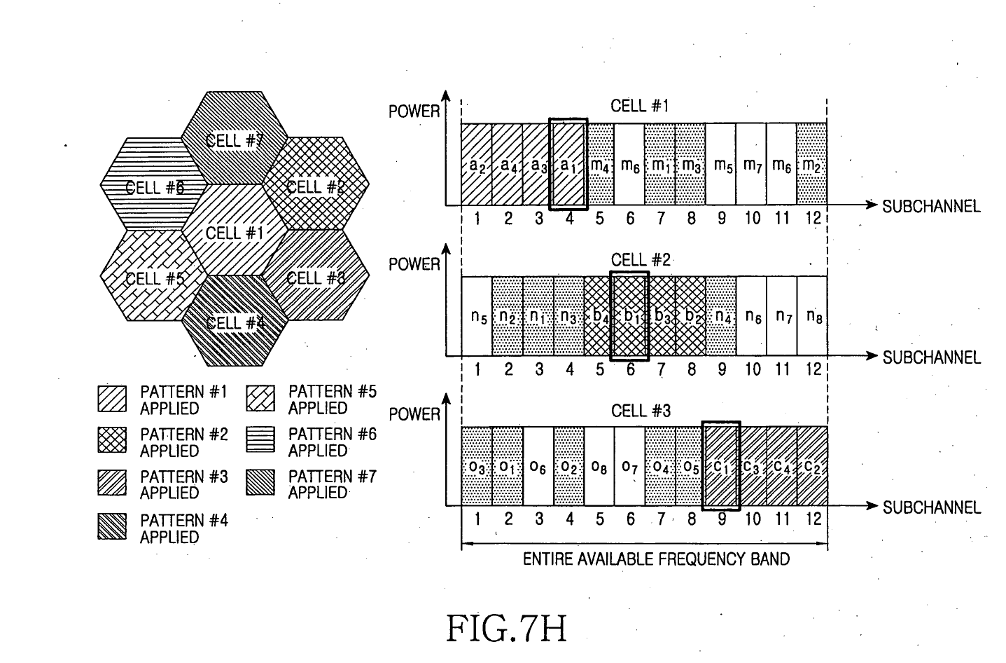

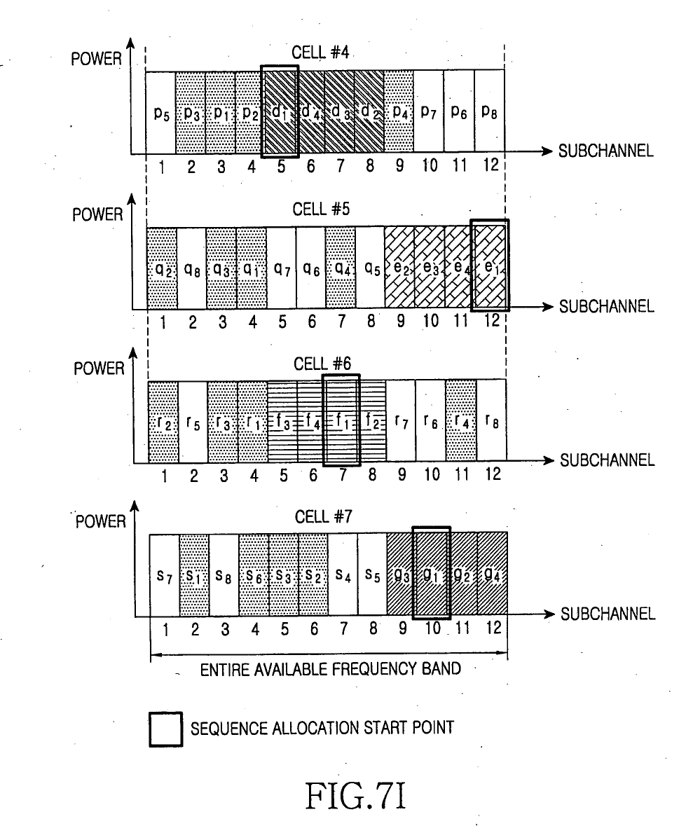

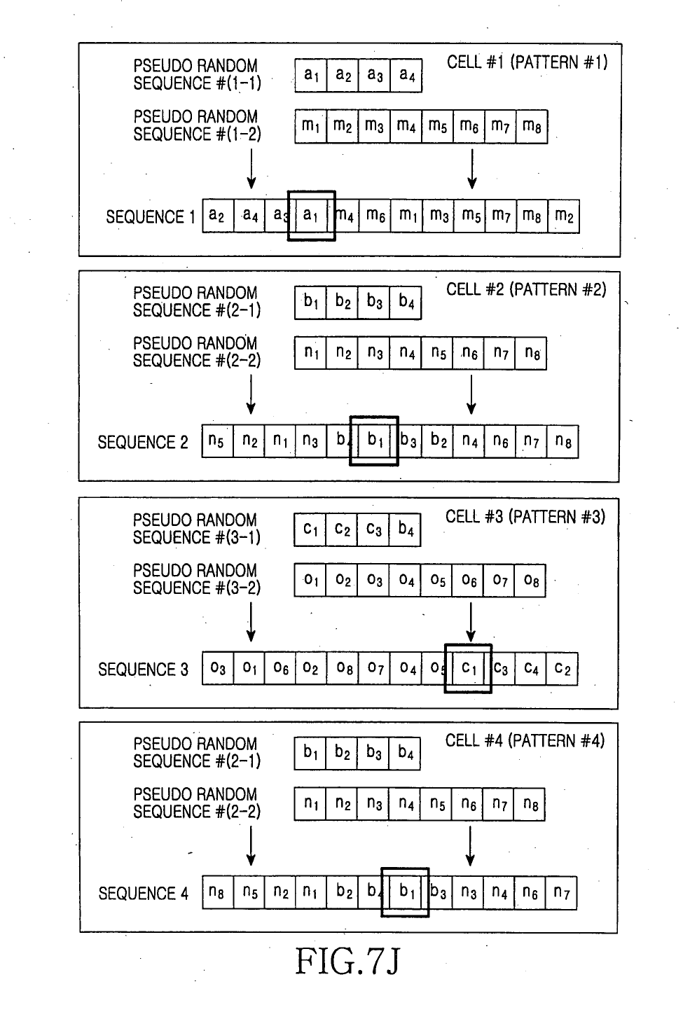

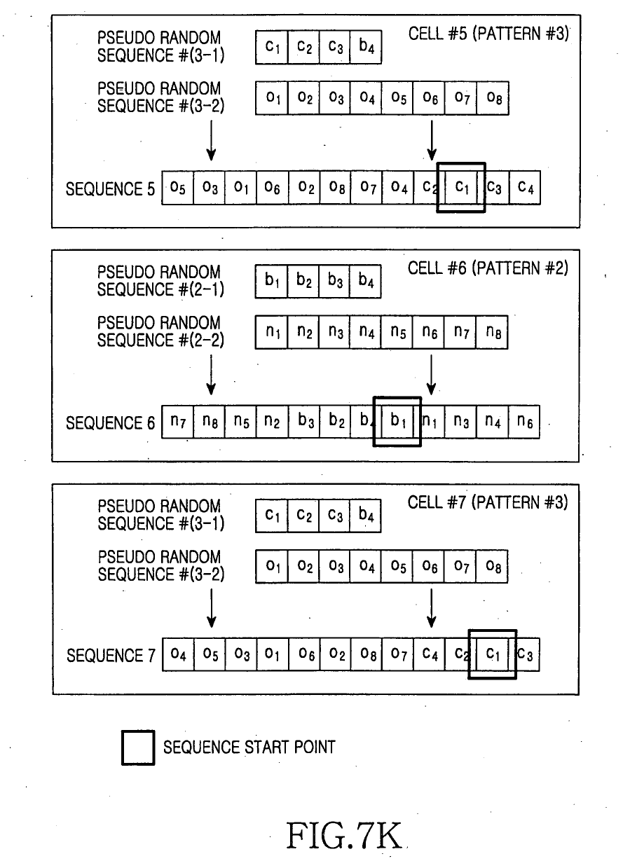

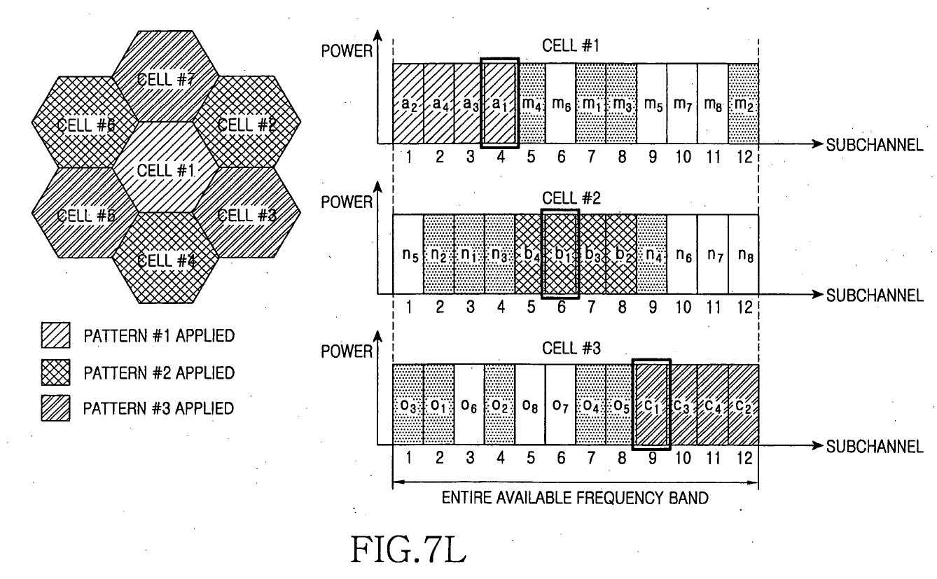

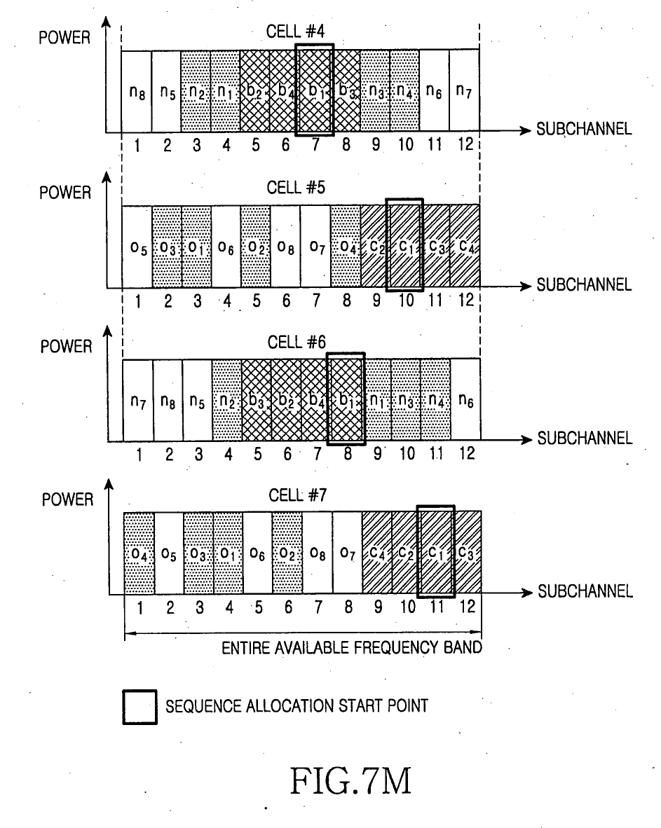

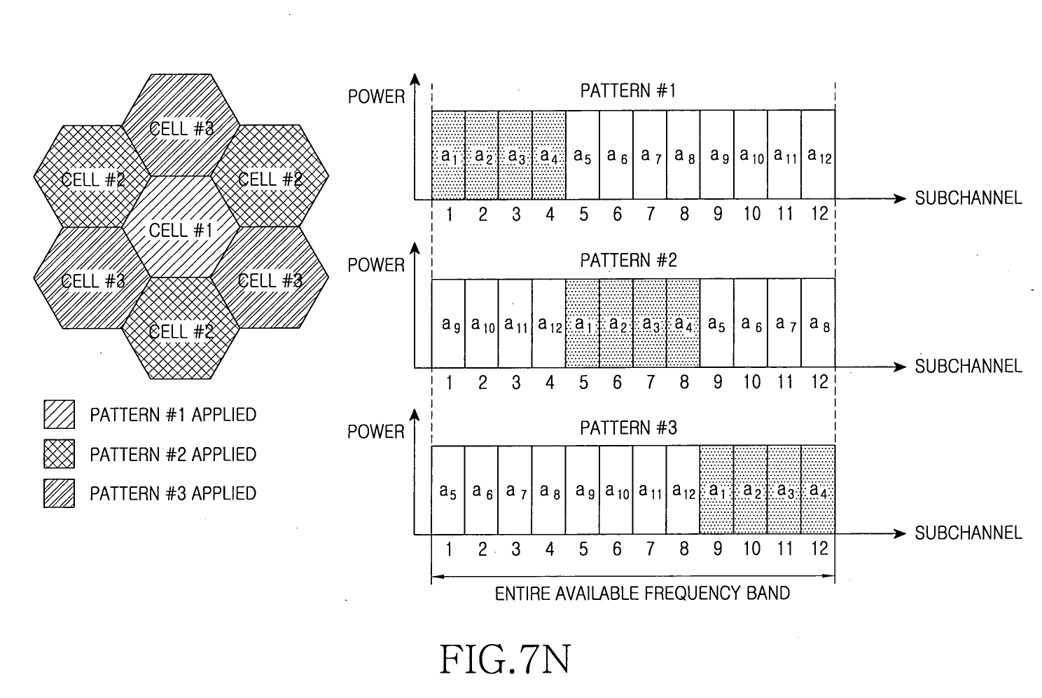

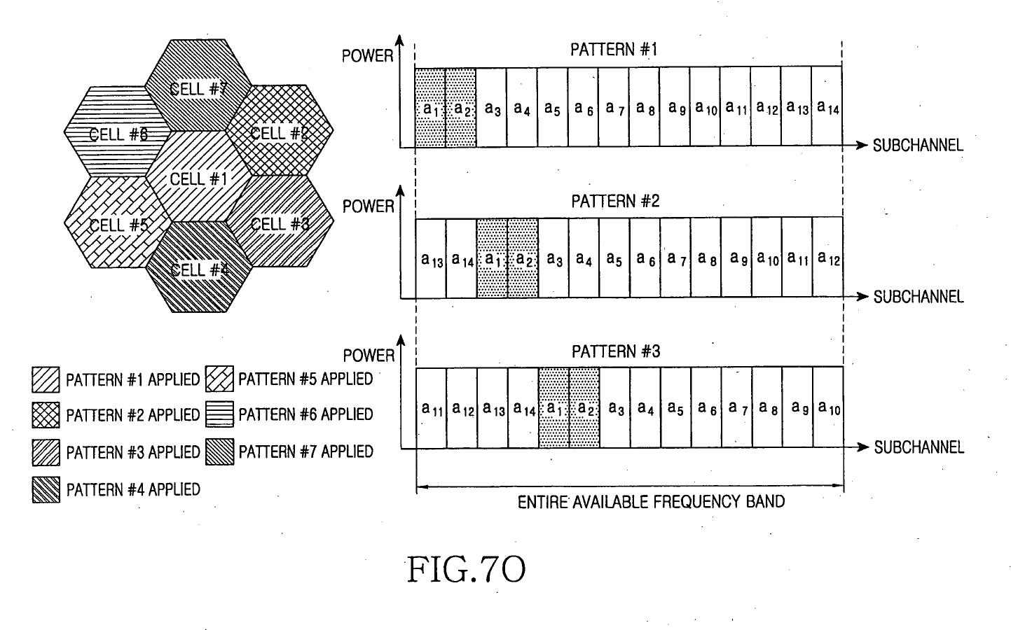

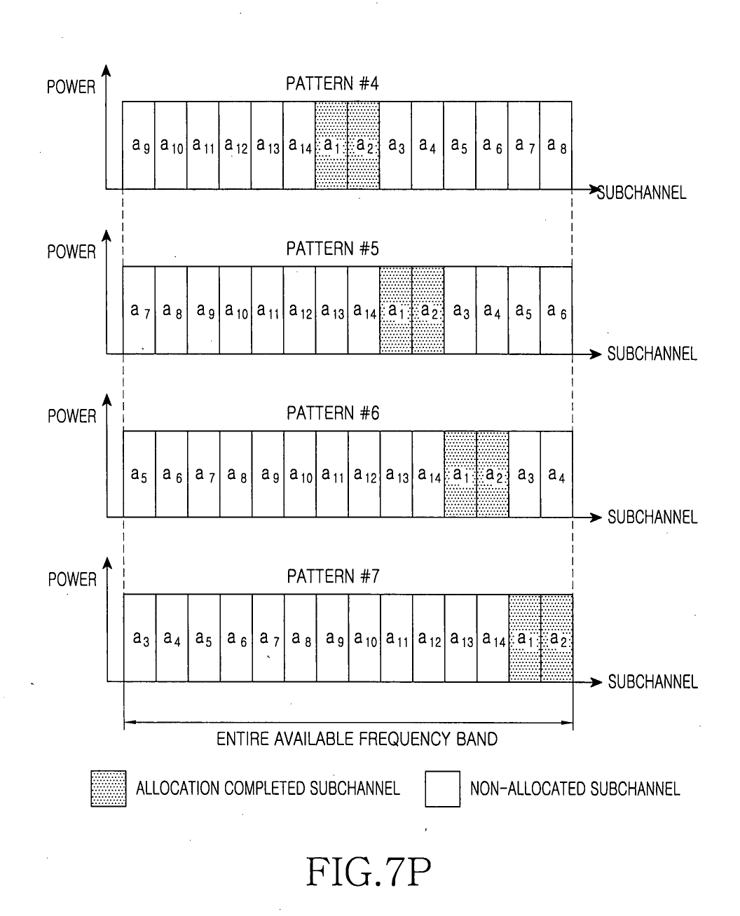

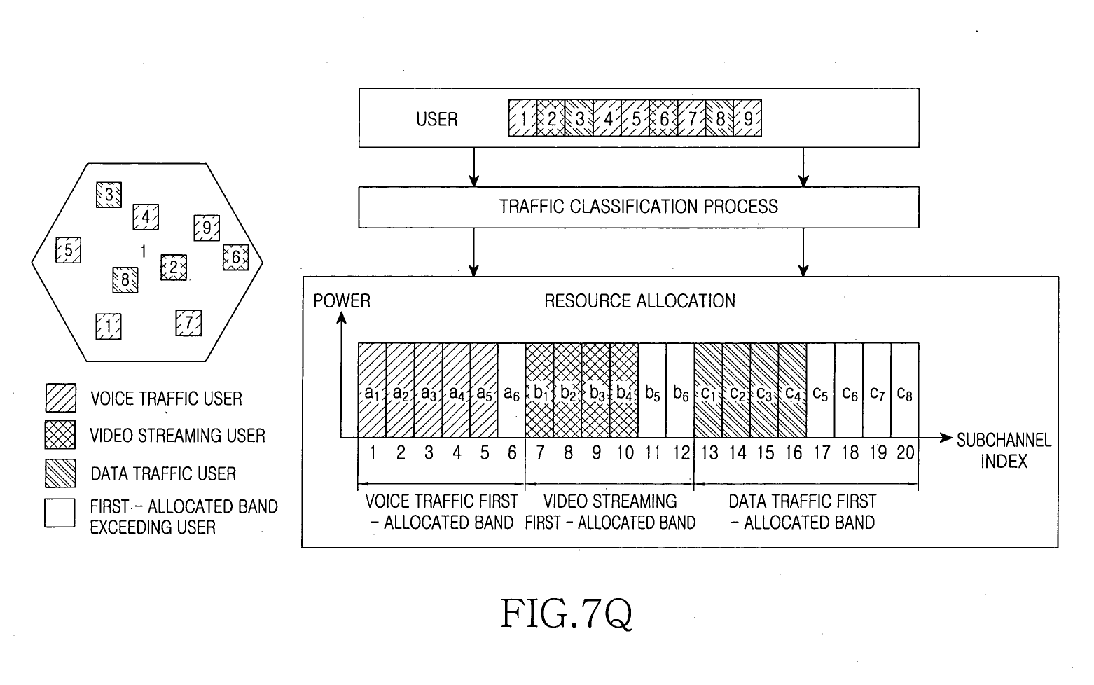

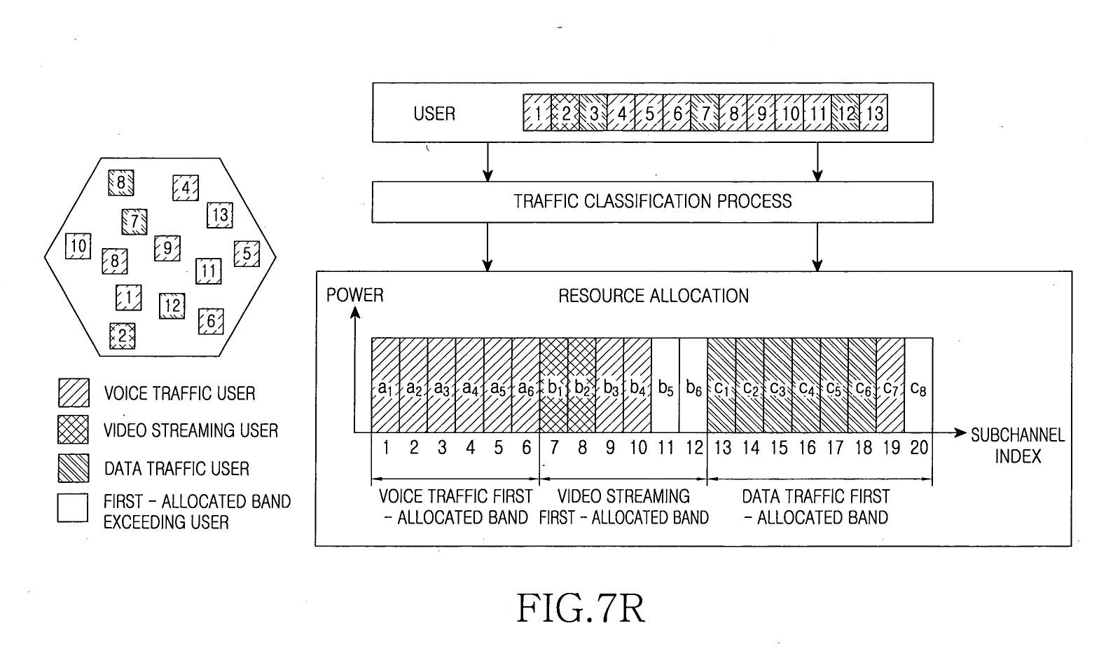

FIGS. 7A to 7R illustrate an operation in which a multi-cell communication system allocates unit subchannels using subchannel allocation sequences according to an embodiment of the present invention. Specifically, FIG. 7A illustrates a resource allocation pattern for a communication system using a forward subchannel allocation sequence. FIG. 7B illustrates resource allocation in a communication system using a forward subchannel allocation sequence in an omni-directional antenna environment. FIG. 7C illustrates resource allocation in a communication system using a forward subchannel allocation sequence in a sector antenna environment. FIG. 7D illustrates a resource allocation pattern for a communication system using a pseudo random subchannel allocation sequence. FIG. 7E illustrates resource allocation in a communication system using a pseudo random subchannel allocation sequence. FIGS. 7F and 7G illustrate resource allocation patterns for a communication system using different pseudo random subchannel allocation sequences by combining pseudo random subchannel allocation sequences having different sequence lengths. FIGS. 7H and 7I illustrate resource allocation in a communication system according to the patterns of FIGS. 7F and 7G FIGS. 7J and 7K illustrate resource allocation patterns for a communication system in which non-adjacent cells use same pseudo random subchannel allocation sequences configured by combining pseudo random subchannel allocation sequences having different sequence lengths. FIGS. 7L and 7M illustrate resource allocation in a communication system according to the patterns of FIGS. 7J and 7K. FIG. 7N illustrates resource allocation in a communication system with frequency reuse factor=3, using subchannel allocation sequences. FIGS. 7O to 7P illustrate resource allocation in a communication system with frequency reuse factor=7, using subchannel allocation sequences. FIGS. 7Q and 7R illustrate resource allocation in a communication system using subchannel allocation sequences corresponding to user data types.

Referring to FIG. 7A, forward subchannel allocation sequences in multiple patterns are configured by cyclic-shifting a forward subchannel allocation sequence by changing a sequence allocation start point, i.e. allocation points of unit subchannels, of the forward subchannel allocation sequence, and unit subchannels corresponding to indexes of the sequences are allocated to users according to the configured forward subchannel allocation sequences. More specifically, a forward subchannel allocation sequence in a pattern #1, having sequence indexes of a₁, a₂, a₃, a₄, a₅, a₆, a₇, a₈, a₉, a₁₀, a₁₁, a₁₂, a forward subchannel allocation sequence in a pattern #2, having sequence indexes of a₉, a₁₀, a₁₁, a₁₂, a₁, a₂, a₃, a₄, a₅, a₆, a₇, a₈, and a forward subchannel allocation sequence in a pattern #3, having sequence indexes of a₄, a₅, a₆, a₇, a₈, a₉, a₁₀, a₁₁, a₁₂, a₁, a₂, a₃ can be defined by changing sequence allocation points in a forward subchannel allocation sequence having sequence indexes of a₁, a₂, a₃, a₄, a₅, . . . , a_{N}. The unit subchannels corresponding to sequence indexes in the patterns are allocated according to the forward subchannel allocation sequences defined in the three types of patterns. Herein, the three types of patterns refer to the patterns of the forward subchannel allocation sequences defined by cyclic-shifting allocation start points of the unit subchannels in three types to allocate the unit subchannels in a multi-cell communication system with frequency reuse factor=3.

Referring to FIGS. 7B and 7C, unit subchannels corresponding to sequence indexes in each pattern are allocated to users according to forward subchannel allocation sequences defined in the three patterns of FIG. 7A in an omni-directional 3-sector antenna environment. More specifically, three cells allocate unit subchannels according to the forward subchannel allocation sequences in the three patterns defined in FIG. 7A, such as sequence indexes of a₁, a₂, a₃, a₄, a₅, a₆, a₇, a₈, a₉, a₁₀, a₁₁, a₁₂, sequence indexes of a₉, a₁₀, a₁₁, a₁₂, a₁, a₂, a₃, a₄, a₅, a₆, a₇, a₈, and sequence indexes of a₄, a₅, a₆, a₇, a₈, a₉, a₁₀, a₁₁, a₁₂, a₁, a₂, a₃, respectively. That is, a first cell allocates unit subchannels corresponding to sequence indexes in a corresponding pattern according to the forward subchannel allocation sequence in pattern #1, a second cell allocates unit subchannels corresponding to sequence indexes in a corresponding pattern according to the forward subchannel allocation sequence in pattern #2, and a third cell allocates unit subchannels corresponding to sequence indexes in a corresponding pattern according to the forward subchannel allocation sequence in pattern #3.

Referring to FIG. 7D, pseudo random subchannel allocation sequences in multiple patterns are configured by cyclic-shifting pseudo random allocation sequences by changing sequence allocation start points, i.e. allocation points of unit subchannels, of the three types of pseudo random subchannel allocation sequences, and unit subchannels corresponding to indexes of the sequences are allocated to users according to the configured pseudo random subchannel allocation sequences. As described above, it will be assumed herein that all cells allocate unit subchannels according to different pseudo random subchannel allocation sequences. More specifically, the pseudo random subchannel allocation sequences can be defined as a pseudo random subchannel allocation sequence in pattern #1, having sequence indexes of a₁₀, a₈, a₅, a₁₁, a₃, a₁₂, a₆, a₄, a₁, a₉, a₂, a₇, a pseudo random subchannel allocation sequence in pattern #2, having sequence indexes of b₄, b₂, b₁₀, b₇, b₁, b₁₂, b₃, b₅, b₁₁, b₈, b₆, b₉, and a pseudo random subchannel allocation sequence in pattern #3, having sequence indexes of c₁₂, c₁₁, c₃, c₅, c₁₀, c₁, c₈, c₆, c₉, c₂, c₇, c₄ by changing sequence allocation points in the three types of the pseudo random subchannel allocation sequences having sequence indexes of a₁, a₂, a₃, a₄, a₅, . . . , a_{N}; b₁, b₂, b₃, b₄, b₅, . . . , b_{N}; and c₁, c₂, c₃, c₄, c₅, . . . , c_{N}. The unit subchannels corresponding to sequence indexes in the patterns are allocated according to the pseudo random subchannel allocation sequences defined in the three types of patterns.

Referring to FIG. 7E, unit subchannels corresponding to sequence indexes in each pattern are allocated to users according to the pseudo random subchannel allocation sequences defined in the three patterns of FIG. 7D. More specifically, three cells allocate unit subchannels according to the pseudo random subchannel allocation sequences in the three patterns defined in FIG. 7D, such as sequence indexes of a₁₀, a₈, a₅, a₁₁, a₃, a₁₂, a₆, a₄, a₁, a₉, a₂, a₇, sequence indexes of b₄, b₂, b₁₀, b₇, b₁, b₁₂, b₃, b₅, b₁₁, b₈, b₆, b₉, and sequence indexes of c₁₂, c₁₁, c₃, c₅, c₁₀, c₁, c₈, c₆, c₉, c₂, c₇, c₄, respectively. That is, a first cell allocates unit subchannels corresponding to sequence indexes in a corresponding pattern according to the pseudo random subchannel allocation sequence in pattern #1, a second cell allocates unit subchannels corresponding to sequence indexes in a corresponding pattern according to the pseudo random subchannel allocation sequence in pattern #2, and a third cell allocates unit subchannels corresponding to sequence indexes in a corresponding pattern according to the pseudo random subchannel allocation sequence in pattern #3.

Referring to FIGS. 7F and 7G, an entire pseudo random subchannel sequence is configured by combining a pseudo random subchannel sequence having a sequence length being equivalent to ⅓ of the number of unit subchannels allocated in the entire available frequency band, with a pseudo random subchannel sequence having a sequence length being equivalent to ⅔ of the number of unit subchannels, and unit subchannels corresponding to indexes of the sequence are allocated to users according to the configured entire pseudo random subchannel allocation sequence. The pseudo random subchannel sequence having the ⅓ sequence length and the pseudo random subchannel sequence having the ⅔ sequence length are different in all cells. Therefore, the configured entire pseudo random subchannel allocation sequence is different in all cells. In addition, pseudo random subchannel allocation sequences in multiple patterns are configured by cyclic-shifting the pseudo random subchannel allocation sequence by changing sequence allocation start points of the configured entire pseudo random subchannel allocation sequence, and unit subchannels corresponding to indexes of the sequences are allocated to users according to the configured pseudo random subchannel allocation sequences.

More specifically, in FIG. 7F, a first cell in a pattern #1 configures an entire pseudo random sequence #1 by combining a pseudo random sequence #(1-1) having the ⅓ sequence length with a pseudo random sequence #(1-2) having the ⅔ sequence length. Herein, a₁, a₂, a₃, a₄ mean sequence indexes of the pseudo random sequence #(1-1), and m₁, m₂, m₃, m₄, m₅, m₆, m₇, m₈ mean sequence indexes of the pseudo random sequence #(1-2). Accordingly, sequence indexes of the combined entire pseudo random sequence #1 are a₁, a₂, a₃, a₄, m₁, m₂, m₃, m₄, m₅, m₆, m₇, m₈, and the sequence allocation start point is a sequence index a₁. In addition, a second cell in a pattern #2 configures an entire pseudo random sequence #2 by combining a pseudo random sequence #(2-1) having the ⅓ sequence length with a pseudo random sequence #(2-2) having the ⅔ sequence length. Herein, b₁, b₂, b₃, b₄ mean sequence indexes of the pseudo random sequence #(2-1), and n₁, n₂, n₃, n₄, n₅, n₆, n₇, n₈ mean sequence indexes of the pseudo random sequence #(2-2). Accordingly, sequence indexes of the combined entire pseudo random sequence #2 are b₁, b₂, b₃, b₄, n₁, n₂, n₃, n₄, n₅, n₆, n₇, n₈, and the sequence allocation start point is a sequence index b₁.

A third cell in a pattern #3 configures an entire pseudo random sequence #3 by combining a pseudo random sequence #(3-1) having the ⅓ sequence length with a pseudo random sequence #(3-2) having the ⅔ sequence length. Herein, c₁, c₂, c₃, c₄ mean sequence indexes of the pseudo random sequence #(3-1), and o₁, o₂, o₃, o₄, o₅, o₆, o₇, o₈ mean sequence indexes of the pseudo random sequence #(3-2). Accordingly, sequence indexes of the combined entire pseudo random sequence #3 are c₁, c₂, c₃, c₄, o₁, o₂, o₃, o₄, o₅, o₆, o₇, o₈, and the sequence allocation start point is a sequence index c₁. A fourth cell in a pattern #4 configures an entire pseudo random sequence #4 by combining a pseudo random sequence #(4-1) having the ⅓ sequence length with a pseudo random sequence #(4-2) having the ⅔ sequence length. Herein, d₁, d₂, d₃, d₄ mean sequence indexes of the pseudo random sequence #(4-1), and p₁, p₂, p₃, p₄, p₅, p₆, p₇, p₈ mean sequence indexes of the pseudo random sequence #(4-2). Accordingly, sequence indexes of the combined entire pseudo random sequence #4 are d₁, d₂, d₃, d₄, p₁, p₂, p₃, p₄, p₅, p₆, p₇, p₈, and the sequence allocation start point is a sequence index d₁.

In FIG. 7G, a fifth cell in a pattern #5 configures an entire pseudo random sequence #5 by combining a pseudo random sequence #(5-1) having the ⅓ sequence length with a pseudo random sequence #(5-2) having the ⅔ sequence length. Herein, e₁, e₂, e₃, e₄ mean sequence indexes of the pseudo random sequence #(5-1), and q₁, q₂, q₃, q₄, q₅, q₆, q₇, q₈ mean sequence indexes of the pseudo random sequence #(5-2). Accordingly, sequence indexes of the combined entire pseudo random sequence #5 are e₁, e₂, e₃, e₄, q₁, q₂, q₃, q₄, q₅, q₆, q₇, q₈, and the sequence allocation start point is a sequence index e₁. A sixth cell in a pattern #6 configures an entire pseudo random sequence #6 by combining a pseudo random sequence #(6-1) having the ⅓ sequence length with a pseudo random sequence #(6-2) having the ⅔ sequence length. Herein, f₁, f₂, f₃, f₄ mean sequence indexes of the pseudo random sequence #(6-1), and r₁, r₂, r₃, r₄, r₅, r₆, r₇, r₈ mean sequence indexes of the pseudo random sequence #(6-2). Accordingly, sequence indexes of the combined entire pseudo random sequence #6 are f₁, f₂, f₃, f₄, r₁, r₂, r₃, r₄, r₅, r₆, r₇, r₈, and the sequence allocation start point is a sequence index f₁.

A seventh cell in a pattern #7 configures an entire pseudo random sequence #7 by combining a pseudo random sequence #(7-1) having the ⅓ sequence length with a pseudo random sequence #(7-2) having the ⅔ sequence length. Herein, g₁, g₂, g₃, g₄ mean sequence indexes of the pseudo random sequence #(7-1), and s₁, s₂, s₃, s₄, s₅, s₆, s₇, s₈ mean sequence indexes of the pseudo random sequence #(7-2). Accordingly, sequence indexes of the combined entire pseudo random sequence #7 are g₁, g₂, g₃, g₄, s₁, s₂, s₃, s₄, s₅, s₆, s₇, s₈, and the sequence allocation start point is a sequence index g₁. To sum up, pseudo random subchannel allocation sequences in multiple patterns are configured by cyclic-shifting the pseudo random subchannel allocation sequences by changing sequence allocation start points, i.e. a₁, b₁, c₁, d₁, e₁, f₁, g₁, of the combined entire pseudo random subchannel allocation sequences, and unit subchannels corresponding to indexes of the sequences are allocated users according to the configured pseudo random subchannel allocation sequences. In this manner, unit subchannels corresponding to sequence indexes in the patterns are allocated according to the pseudo random subchannel allocation sequences defined in different patterns for the cells.

Referring to FIGS. 7H and 7I, unit subchannels corresponding to sequence indexes in the patterns are allocated to users according to pseudo random subchannel allocation sequences defined in different patterns for the cells as shown in FIGS. 7F and 7G. More specifically, a first cell allocates unit subchannels corresponding to sequence indexes of a₁, a₂, a₃, a₄, m₁, m₂, m₃, m₄, m₅, m₆, m₇, m₈, a second cell allocates unit subchannels corresponding to sequence indexes of b₁, b₂, b₃, b₄, n₁, n₂, n₃, n₄, n₅, n₆, n₇, n₈, and a third cell allocates unit subchannels corresponding to sequence indexes of c₁, c₂, c₃, c₄, o₁, o₂, o₃, o₄, o₅, o₆, o₇, o₈. In addition, in FIG. 7I, a fourth cell allocates unit subchannels corresponding to sequence indexes of d₁, d₂, d₃, d₄, p₁, p₂, p₃, p₄, p₅, p₆, p₇, p₈, a fifth cell allocates unit subchannels corresponding to sequence indexes of e₁, e₂, e₃, e₄, q₁, q₂, q₃, q₄, q₅, q₆, q₇, q₈, a sixth cell allocates unit subchannels corresponding to sequence indexes of f₁, f₂, f₃, f₄, r₁, r₂, r₃, r₄, r₅, r₆, r₇, r₈, and a seventh cell allocates unit subchannels corresponding to sequence indexes of g₁, g₂, g₃, g₄, s₁, s₂, s₃, s₄, s₅, s₆, s₇, s₈.

Referring to FIGS. 7J and 7K, an entire pseudo random subchannel sequence is configured by combining a pseudo random subchannel sequence having a sequence length being equivalent to ⅓ of the number of unit subchannels allocated in the entire available frequency band, with a pseudo random subchannel sequence having a sequence length being equivalent to ⅔ of the number of unit subchannels, and unit subchannels corresponding to indexes of the sequence are allocated to users according to the configured entire pseudo random subchannel allocation sequence. The pseudo random subchannel sequence having the ⅓ sequence length and the pseudo random subchannel sequence having the ⅔ sequence length are equal in all non-adjacent cells. Therefore, the configured entire pseudo random subchannel allocation sequence is equal in all non-adjacent cells. In addition, pseudo random subchannel allocation sequences in multiple patterns are configured by cyclic-shifting the pseudo random subchannel allocation sequence by changing sequence allocation start points of the configured entire pseudo random subchannel allocation sequence, and unit subchannels corresponding to indexes of the sequences are allocated to users according to the configured pseudo random subchannel allocation sequences.

More specifically, a first cell in a pattern #1 configures an entire pseudo random sequence #1 by combining a pseudo random sequence #(1-1) having the ⅓ sequence length with a pseudo random sequence #(1-2) having the ⅔ sequence length. Herein, a₁, a₂, a₃, a₄ mean sequence indexes of the pseudo random sequence #(1-1), and m₁, m₂, m₃, m₄, m₅, m₆, m₇, m₈ mean sequence indexes of the pseudo random sequence #(1-2). Accordingly, sequence indexes of the combined entire pseudo random sequence #1 are a₁, a₂, a₃, a₄, m₁, m₂, m₃, m₄, m₅, m₆, m₇, m₈, and the sequence allocation start point is a sequence index a₁. In addition, a second cell in a pattern #2 configures an entire pseudo random sequence #2 by combining a pseudo random sequence #(2-1) having the ⅓ sequence length with a pseudo random sequence #(2-2) having the ⅔ sequence length. Herein, b₁, b₂, b₃, b₄ mean sequence indexes of the pseudo random sequence #(2-1), and n₁, n₂, n₃, n₄, n₅, n₆, n₇, n₈ mean sequence indexes of the pseudo random sequence #(2-2). Accordingly, sequence indexes of the combined entire pseudo random sequence #2 are b₁, b₂, b₃, b₄, n₁, n₂, n₃, n₄, n₅, n₆, n₇, n₈, and the sequence allocation start point is a sequence index b₁.

A third cell in a pattern #3 configures an entire pseudo random sequence #3 by combining a pseudo random sequence #(3-1) having the ⅓ sequence length with a pseudo random sequence #(3-2) having the ⅔ sequence length. Herein, c₁, c₂, c₃, c₄ mean sequence indexes of the pseudo random sequence #(3-1), and o₁, o₂, o₃, o₄, o₅, o₆, o₇, o₈ mean sequence indexes of the pseudo random sequence #(3-2). Accordingly, sequence indexes of the combined entire pseudo random sequence #3 are c₁, c₂, c₃, c₄, o₁, o₂, o₃, o₄, o₅, o₆, o₇, o₈, and the sequence allocation start point is a sequence index cl. A fourth cell, as it is not adjacent to the second cell, configures the same entire pseudo random sequence as that in pattern #2 for the second cell, and a fifth cell, as it is not adjacent to the third cell, configures the same entire pseudo random sequence as that in pattern #3 for the third cell. A sixth cell, as it is not adjacent to the second cell, configures the same entire pseudo random sequence as that in pattern #2 for the second cell, and a seventh cell, as it is not adjacent to the third cell, configures the same entire pseudo random sequence as that in pattern #3 for the third cell. That is, unit subchannels corresponding to the same sequence indexes are allocated according to the same entire pseudo random sequences. To sum up, pseudo random subchannel allocation sequences in multiple patterns are configured by cyclic-shifting the pseudo random subchannel allocation sequences by changing sequence allocation start points, i.e. a₁, b₁, c₁, of the configured entire pseudo random subchannel allocation sequences, and unit subchannels corresponding to indexes of the sequences are allocated to users according to the configured pseudo random subchannel allocation sequences. In this manner, unit subchannels corresponding to sequence indexes in the patterns are allocated according to the pseudo random subchannel allocation sequences defined in different patterns for the cells.

Referring to FIGS. 7L and 7M, unit subchannels corresponding to sequence indexes in the patterns are allocated to users according to pseudo random subchannel allocation sequences defined in different patterns for the non-adjacent cells as shown in FIGS. 7I and 7J. More specifically, a first cell allocates unit subchannels corresponding to sequence indexes of a₁, a₂, a₃, a₄, m₁, m₂, m₃, m₄, m₅, m₆, m₇, m₈, and a second cell, a fourth cell and a sixth cell allocate unit subchannels corresponding to sequence indexes of b₁, b₂, b₃, b₄, n₁, n₂, n₃, n₄, n₅, n₆, n₇, n₈. A third cell, a fifth cell and a seventh cell allocate unit subchannels corresponding to sequence indexes of c₁, c₂, c₃, c₄, o₁, o₂, o₃, o₄, o₅, o₆, o₇, o₈.

Referring to FIGS. 7N, 7O and 7P, a communication system with frequency reuse factor=3 and frequency reuse factor=7 allocates unit subchannels corresponding to sequence indexes in individual patterns according to subchannel allocation sequences defined in different patterns for the cells. As described above, subchannel allocation sequences in multiple patterns are configured by cyclic-shifting subchannel allocation sequences by changing sequence allocation start points of the subchannel allocation sequences, and unit subchannels corresponding to indexes of the sequences are allocated to users according to the configured subchannel allocation sequences. Herein, as many patterns as the number being equivalent to the frequency reuse factor are configured by cyclic-shifting the same subchannel allocation sequences by changing allocation start points of unit subchannels in the same subchannel allocation sequences according to the frequency reuse factor in the multi-cell communication system.

Referring to FIG. 7Q, a subchannel sequence corresponding to N unit subchannels in the entire frequency band can be configured by combining several short sequences whose sequence length is shorter than N, such that the total length of the combined subchannel allocation sequences is equivalent to the number of unit subchannels in the entire frequency band. Thereafter, the short sequences are independently used according to the usage of users, for example, according to traffic type. More specifically, if 20 unit subchannels are allocated in the entire available frequency band, the entire sequence having a length being equivalent to the number of the unit subchannels is configured by combining subchannel allocation sequences predefined separately for traffic types, i.e. by combining a voice traffic subchannel allocation sequence with sequence length=6, a video streaming subchannel allocation sequence with sequence length=6, and a data traffic subchannel allocation sequence with sequence length=8. Herein, a₁, a₂, a₃, a₄, a₅, a₆ mean sequence indexes of the voice traffic subchannel allocation sequence, b₁, b₂, b₃, b₄, b₅, b₆ mean sequence indexes of the video streaming subchannel allocation sequence, and c₁, c₂, c₃, c₄, c₅, c₆, c₇, c₈ mean sequence indexes of the data traffic subchannel allocation sequence. Although the short sequences are independently used according to the usage of users, for example, according to traffic type in the foregoing description of an embodiment of the present invention, the short sequences can be independently used according to the usage of various users and communication systems, for example, according to CQI of the users, separately for a low-CQI user group and a high-CQI user group. In addition, the short sequences can be independently used according to service class provided to the users. The service class is not directly related to the present invention, so a detailed description thereof will be omitted herein.

When unit subchannels are allocated to users #1, #4, #5, #7 and #9 using voice traffic, users #2 and #6 using video streaming, and users #3 and #8 using data traffic, the users are classified according to traffic type. Of the classified users, the users #1, #4, #5, #7 and #9 using voice traffic are allocated unit subchannels #1, #2, #3, #4 and #5 corresponding to the sequence indexes according to the voice traffic subchannel allocation sequence, the users #2 and #6 using video streaming are allocated unit subchannels #7, #8, #9 and #10 corresponding to the sequence indexes according to the video streaming sub channel allocation sequence, and the users #3 and #8 using data traffic are allocated unit subchannels #13, #14, #15 and #16 corresponding to the sequence indexes according to the data traffic subchannel allocation sequence. That is, the users are allocated the unit subchannels corresponding to the sequence indexes according to the sequences predefined separately for traffic types.

Referring to FIG. 7R, as described in FIG. 7Q, a subchannel sequence corresponding to N unit subchannels in the entire frequency band can be configured by combining several short sequences whose sequence length is shorter than N, such that the total length of the combined sequences is. equivalent to the number of unit subchannels in the entire frequency band. Thereafter, the short sequences are independently used according to the usage of users, for example, according to traffic type. More specifically, if 20 unit subchannels are allocated in the entire available frequency band, the entire sequence having a length being equivalent to the number of the unit subchannels is configured by combining a voice traffic subchannel allocation sequence with sequence length=6, a video streaming subchannel allocation sequence with sequence length=6, and a data traffic subchannel allocation sequence with sequence length=8. Herein, a₁, a₂, a₃, a₄, a₅, a₆ mean sequence indexes of the voice traffic subchannel allocation sequence, b₁, b₂, b₃, b₄, b₅, b₆ mean sequence indexes of the video streaming subchannel allocation sequence, and c₁, c₂, c₃, c₄, c₅, c₆, c₇, c₈ mean sequence indexes of the data traffic subchannel allocation sequence.

When unit subchannels are allocated to users #1, #4, #5, #6, #8, #9, #10, #11 and #13 using voice traffic, a user #2 using video streaming, and users #3, #7 and #12 using data traffic, the users are classified according to traffic type. Of the classified users, the users #1, #4, #5, #6, #8, #9, #10, #11 and #13 using voice traffic are allocated unit subchannels #1, #2, #3, #4, #5 and #6 corresponding to the sequence indexes according to the voice traffic subchannel allocation sequence, the user #2 using video streaming are allocated unit subchannels #7 and #8 corresponding to the sequence indexes according to the video streaming subchannel allocation sequence, and the users #3, #7 and #12 using data traffic are allocated unit subchannels #13, #14, #15, #16, #17 and #18 corresponding to the sequence indexes according to the data traffic subchannel allocation sequence.

Herein, as the unit subchannels that the users #1, #4, #5, #6, #8, #9, #10, #11 and #13 using voice traffic desire to be allocated exceeds in number the unit subchannels corresponding to the indexes of the voice traffic subchannel allocation sequence, the unit subchannels #9 and #10 not allocated to the user #2 using video streaming and the unit subchannel #19 not allocated to the users #3, #7 and #12 using data traffic are allocated to the users. When the unit subchannels corresponding to the indexes of the sequence are allocated to the users for the individual traffic types according to the subchannel allocation sequences predefined separately for the traffic types, and if the number of users using an arbitrary one traffic increases, unit subchannels corresponding to the indexes of the subchannel allocation sequence predefined for the traffic, other than the arbitrary one traffic, having a less number of users can be allocated. Accordingly, the resources can be efficiently used by allowing the other unit subchannels exceeding the previously allocated unit subchannels to be used.

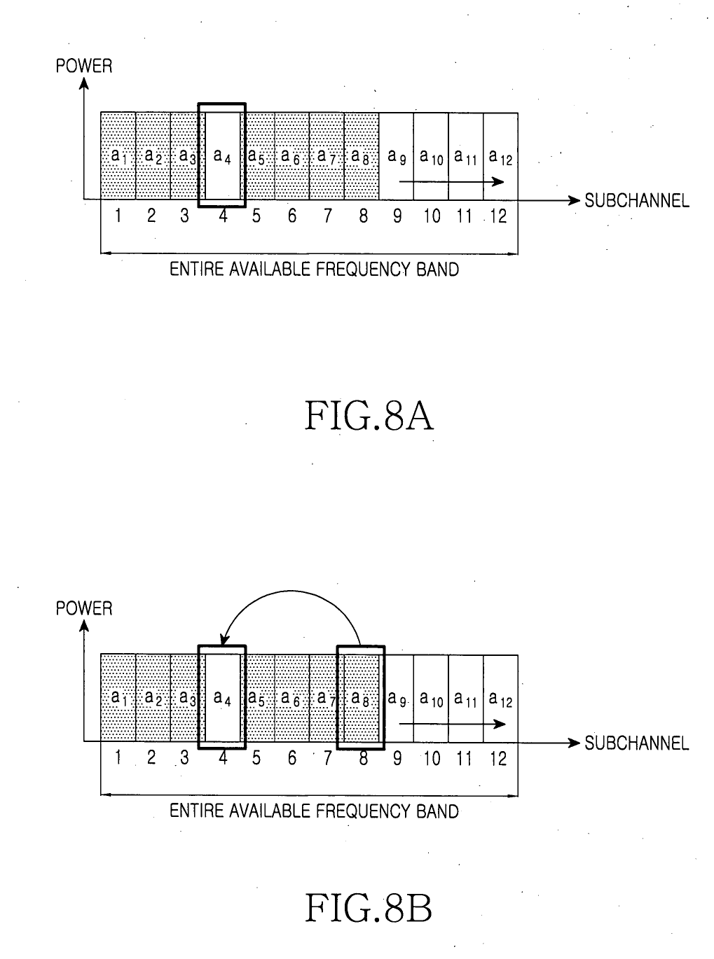

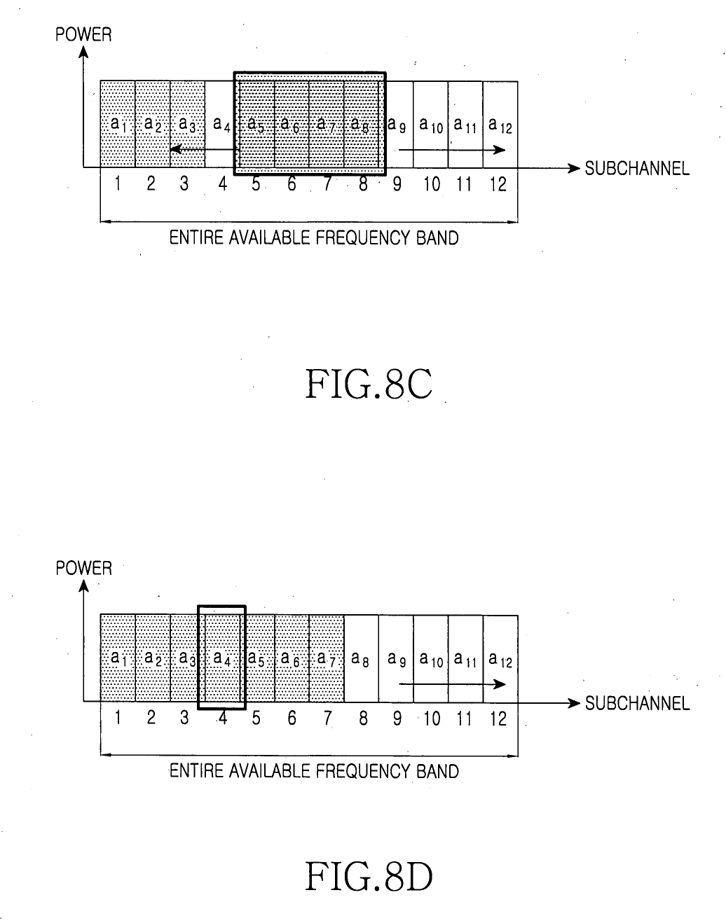

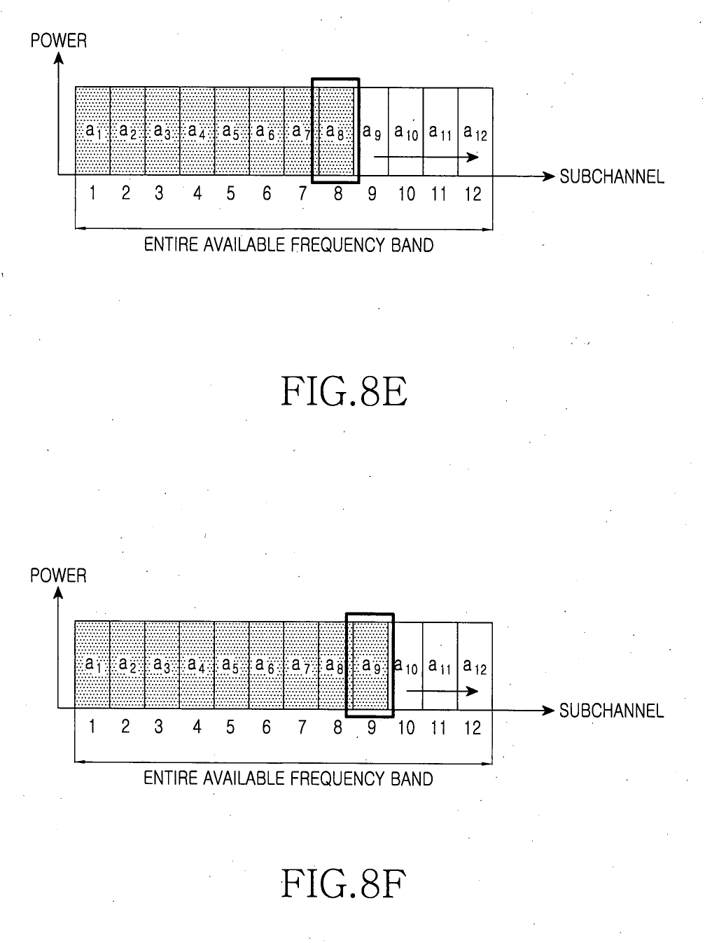

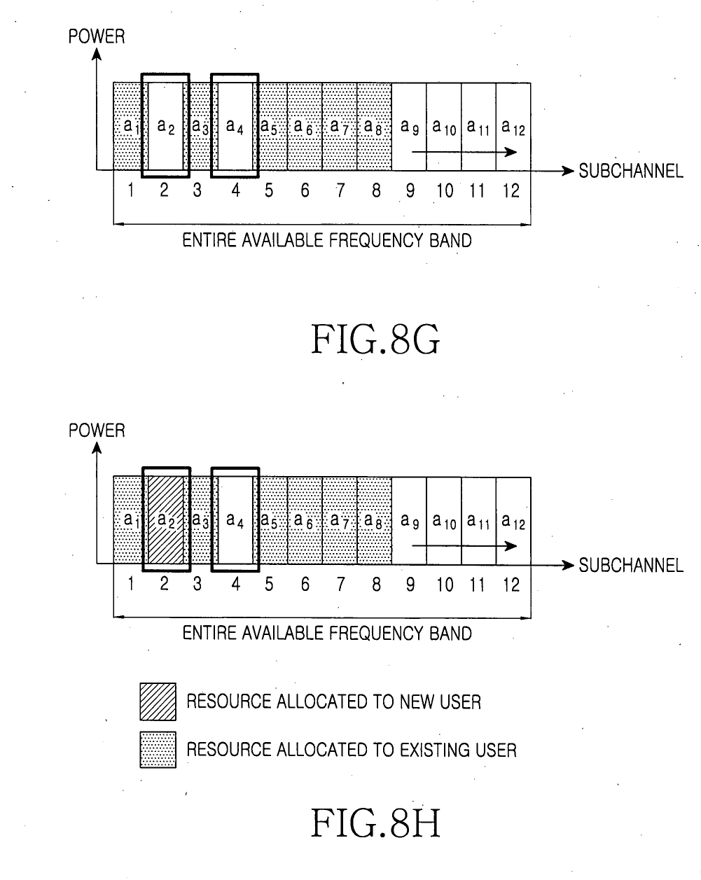

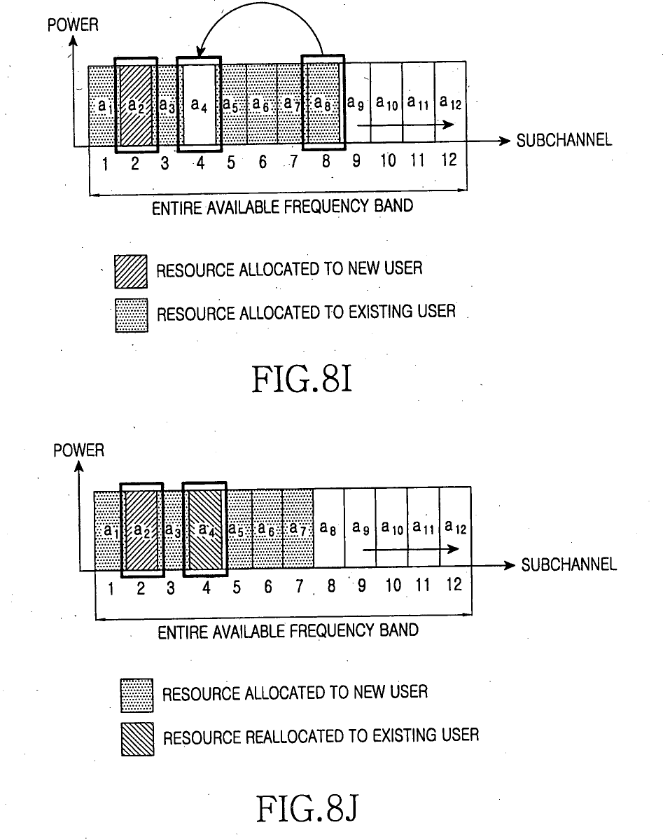

FIGS. 8A to 8J illustrate Dynamic Channel Allocation (DCA) in a multi-cell communication system according to an embodiment of the present invention. Specifically, FIG. 8A illustrates a method for searching for an empty unit subchannel (or unit subchannel not in use) among the unit subchannels allocated according to a predefined subchannel allocation sequence. FIGS. 8B to 8D illustrate methods for reallocating an empty unit subchannel according to the search result. FIGS. 8E and 8F illustrate methods for allocating unit subchannels to a new user when there is no empty unit subchannel as a result of the search in FIG. 8A. FIGS. 8G to 8J illustrate methods for reallocating an empty unit subchannel and allocating unit subchannels to a new user when there is an empty unit subchannel as a result of the search in FIG. 8A. The search for the allocated unit subchannels and the reallocation of the unit subchannels according to the search result are performed at resource allocation periods, for example, at periods of frame.

Referring to FIG. 8A, while communication is performed through unit subchannels corresponding to sequence indexes, allocated according to a predefined subchannel allocation sequence, use of the allocated unit subchannels may be interrupted due to a change in communication environment, for example, handover, communication termination, communication interrupt, and the like, or there may be a need for allocation of new unit subchannels. More specifically, the interrupted use of a unit subchannel #4 corresponding to an index a₄ of the subchannel allocation sequence is searched as shown in FIG. 8A. Thereafter, the unit subchannel #4 corresponding to the index a₄ is reallocated in order to use the searched unit subchannel #4, use of which is interrupted. The reallocation, as shown in FIG. 8B, can reallocate an empty channel, i.e. the unit subchannel #4 corresponding to the index a₄, to the user last allocated a unit subchannel in the entire available frequency band, i.e. the user allocated a unit subchannel #8 corresponding to an index a₈. Alternatively, the reallocation, as shown in FIG. 8C, can reallocate unit subchannels by shifting unit subchannels #5, #6, #7 and #8 corresponding to indexes a₅ to a₈ of the subchannel allocation sequence toward the empty channel, i.e. the unit subchannel #4 corresponding to the index a₄.

When the use of the allocated unit subchannels is interrupted or when reallocation of unit subchannels is performed in case of need for allocation of new unit subchannels, the subchannel allocation sequence used for allocating unit subchannels allocated in the previous resource allocation period before the search is reset. That is, when reallocation of unit subchannels is performed in case of need for allocation of new unit subchannels, allocation of the previously allocated unit subchannels is reset, and the unit subchannels are reallocated. More specifically, allocation of unit subchannels corresponding to a specific unit subchannel allocation sequence defined in the previous resource allocation period is reset, a new unit subchannel allocation sequence is defined, and unit subchannels are reallocated according to the newly defined unit subchannel allocation sequence. The method of defining a unit subchannel allocation sequence and allocating unit subchannels according to the defined unit subchannel allocation sequence has been described above in detail.

Referring to FIGS. 8E and 8F, when a new user exists in the cell due to a change in communication environment, for example, due to handover, in order to allocate a unit subchannel to the new user, it is determined whether there is any empty unit subchannel among the allocated unit subchannels, as described in FIG. 8A. If there is no empty unit subchannel, the last unit subchannel is allocated to the new user. In other words, a unit subchannel following the unit subchannel #8 corresponding to an index a₈ of the subchannel allocation sequence, i.e. a unit subchannel #9 corresponding to an index a₉ of the subchannel allocation sequence, is allocated to the new user as shown in FIGS. 8E and 8F.

Referring to FIGS. 8G and 8J, when a new user exists in the cell due to a change in communication environment, for example, due to handover, in order to allocate a unit subchannel to the new user, it is determined whether there is any empty unit subchannel among the allocated unit subchannels, as described in FIG. 8A. If there are empty unit subchannels, i.e. if unit subchannels #2 and #4 corresponding to indexes a₂ and a₄ of the subchannel allocation sequence are empty channels, the unit subchannel #2 corresponding to the index a₂ of the subchannel allocation sequence is allocated to the new user, and the unit subchannel #4 corresponding to the index a₄ of the subchannel allocation sequence is allocated to the existing user who is allocated the last unit subchannel, i.e. the unit subchannel #8 corresponding to an index a₈ of the subchannel allocation sequence. The DCA of searching for an empty unit subchannel and reallocating unit subchannels according to the search result operates at resource allocation periods, for example, at periods of frame, thereby maintaining patterns of the predefined subchannel allocation sequences. In addition, the DCA reallocates unit subchannels in units of frames, contributing to an increase in resource efficiency.

As can be understood from the foregoing description, the multi-cell communication system according to the present invention allocates resources according to sequences predefined for individual cells, thereby enabling control and estimation of ICI and thus minimizing occurrence of the ICI. In this manner, resource efficiency can be maximized. In addition, the present invention can define sequences in various patterns for the individual cells and manage independent sequences according to traffic type, causing an increase in system efficiency. Further, the present invention simplifies the resource allocation procedure, increasing the system performance, and periodically reallocates resources, increasing resource efficiency.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for using resources in a multi-cell communication system, the method comprising:
dividing a frequency band used in the multi-cell communication system into a plurality of unit subchannels; and
allocating the unit subchannels according to a sequence which is predefined in each cell in an allocation order of the unit subchannels depending on identifier information of multiple cells.

2. The method of claim 1, wherein the predefined sequence is combined with at least one sequence having a predetermined length, wherein a total length of the combined sequences is equivalent to a total number of the unit subchannels.

3. The method of claim 1, wherein the predefined sequence is combined with at least one sequence having a predetermined length, wherein a total length of the combined sequences is less than a total number of the unit subchannels.

4. The method of claim 3, wherein the predefined sequence is defined in one of a consecutive partial frequency band and an inconsecutive partial frequency band in the communication system.

5. The method of claim 1, wherein the unit subchannel includes a predetermined number of subcarriers or segment bands.

6. The method of claim 1, wherein the unit subchannel is defined such that it has the same configuration or different configurations in all of the multiple cells.

7. The method of claim 1, wherein the unit subchannel is defined such that it has the same configuration in all cells in a first group and a second group, each having predetermined cells among the multiple cells.

8. The method of claim 1, wherein the unit subchannel is defined such that it has different configurations in predetermined adjacent cells among the multiple cells.

9. The method of claim 1, wherein the allocation of the unit subchannels comprises sequentially allocating the unit subchannels with the same sequence in all of the multiple cells.

10. The method of claim 1, wherein the allocation of the unit subchannels comprises sequentially allocating the unit subchannels with different sequences in all of the multiple cells.

11. The method of claim 1, wherein the allocation of the unit subchannels comprises defining a resource allocation sequence set in units of groups each having predetermined adjacent cells among the multiple cells, and then sequentially allocating unit subchannels corresponding to indexes of the predefined sequence.

12. The method of claim 11, wherein the resource allocation sequence set is defined such that it is equal in all cells in the cell group.

13. The method of claim 11, wherein the resource allocation sequence set is defined such that it is different in all cells in the cell group.

14. The method of claim 11, wherein the allocation of the unit subchannels comprises generating at least one sequence pattern, which is determined according to a frequency reuse factor of the multi-cell communication system, by cyclic-shifting the sequence predefined in each cell in a manner of adjusting a sequence allocation start point of the unit subchannels, which is equal in all of the multiple cells, and sequentially allocating the unit subchannels according to the generated sequence pattern.

15. The method of claim 11, wherein the allocation of the unit subchannels comprises generating at least one sequence pattern, which is determined according to a frequency reuse factor of the multi-cell communication system, by cyclic-shifting the sequence predefined in each cell in a manner of adjusting a sequence allocation start point of the unit subchannels, which is different in predetermined cells among the multiple cells, and sequentially allocating the unit subchannels according to the generated sequence pattern.

16. The method of claim 11, wherein the allocation of the unit subchannels comprises generating at least one sequence pattern, which is determined according to a frequency reuse factor of the multi-cell communication system, by cyclic-shifting the sequence predefined in each cell in a manner of adjusting a sequence allocation start point of the unit subchannels, which is equal in all cells in a cell group having predetermined adjacent cells among the multiple cells, and sequentially allocating the unit subchannels according to the generated sequence pattern.

17. The method of claim 11, wherein the allocation of the unit subchannels comprises generating at least one sequence pattern, which is determined according to a frequency reuse factor of the multi-cell communication system, by cyclic-shifting the sequence predefined in each cell in a manner of adjusting a sequence allocation start point of the unit subchannels, which is different in predetermined cells in a cell group having predetermined cells among the multiple cells, and sequentially allocating the unit subchannels according to the generated sequence pattern.

18. The method of claim 1, wherein the allocation of the unit subchannels comprises allocating unit subchannels taking into account at least one of a system requirement of the multi-cell communication system and a user requirement.

19. The method of claim 1, wherein the allocation of the unit subchannels comprises defining and combining at least one sequence having a predetermined length according to traffic type of a user, and allocating unit subchannels according to a sequence corresponding to individual traffic, among the combined sequences.

20. The method of claim 19, wherein the allocation of the unit subchannels comprises allocating non-allocated unit subchannels for other traffic according to a sequence corresponding to the other traffic, when unit subchannels needed by arbitrary traffic exceed in number the unit subchannels allocated according to a sequence corresponding to the arbitrary traffic.

21. The method of claim 1, wherein the allocation of the unit subchannels comprises defining and combining at least one sequence having a predetermined length according to a service class of a user, and allocating unit subchannels according to a sequence corresponding to an individual service class, among the combined sequences.

22. The method of claim 21, wherein the allocation of the unit subchannels comprises allocating non-allocated unit subchannels for other service class according to a sequence corresponding to the other service classes, when unit subchannels needed by an arbitrary service class exceed in number the unit subchannels allocated according to a sequence corresponding to the arbitrary service classes.

23. The method of claim 1, wherein the allocation of the unit subchannels comprises defining and combining at least one sequence having a predetermined length according to a user group, and allocating unit subchannels according to a sequence corresponding to an individual user group, among the combined sequences.

24. The method of claim 23, wherein the allocation of the unit subchannels comprises allocating non-allocated unit subchannels for other user groups according to a sequence corresponding to the other user groups, when unit subchannels needed by an arbitrary user group exceed in number the unit subchannels allocated according to a sequence corresponding to the arbitrary user group.

25. The method of claim 1, wherein the allocation of the unit subchannels comprises sequentially allocating unit subchannels according to at least one of a forward sequence, a reverse sequence, a center-direction sequence, an edge-direction sequence, a pseudo random sequence, and a specific code-defined sequence.

26. The method of claim 25, wherein the specific code-defined sequence is a Latin-square code-defined sequence.

27. The method of claim 1, wherein the allocation of the unit subchannels comprises allocating the unit subchannels using a Dynamic Channel Allocation (DCA) scheme.

28. The method of claim 27, wherein the allocation of the unit subchannels using a DCA scheme comprises:
determining use and nonuse of the allocated unit subchannels at resource allocation periods; and
reallocating unused unit subchannels according to the determination result.

29. The method of claim 27, wherein the allocation of the unit subchannels using a DCA scheme comprises:
determining use and nonuse of the allocated unit subchannels and presence and absence of a new user at resource allocation periods; and
if it is determined that there is an unused unit subchannel and there is a new user, reallocating the unused unit subchannel to the new user.

30. The method of claim 29, wherein the allocation of the unit subchannels using a DCA scheme comprises:
if it is determined that there is no unused unit subchannel and there is a new user, reallocating a unit subchannel to the new user according to a predefined sequence.

31. The method of claim 27, wherein the allocation of the unit subchannels using a DCA scheme comprises:
determining use and nonuse of the allocated unit subchannels and presence and absence of a new user at resource allocation periods;
if it is determined that there is a need for reallocation of the allocated unit subchannels, resetting the sequence predefined in each cell, and redefining a sequence for each cell; and
reallocating the unit subchannels according to the sequence redefined for each cell.

32. A method for using resources in a multi-cell communication system, the method comprising:
dividing resources used in the multi-cell communication system into a plurality of unit subchannels; and
periodically reallocating the unit subchannels according to a resource allocation sequence using a Dynamic Channel Allocation (DCA) scheme for each cell among the multiple cells.

33. The method of claim 32, wherein the DCA scheme comprises:
determining use and nonuse of the allocated unit subchannels at resource allocation periods; and
reallocating an unused unit subchannel as a result of the determination.

34. The method of claim 32, wherein the DCA scheme comprises:
determining use and nonuse of the allocated unit subchannels and presence and absence of a new user at resource allocation periods;
if it is determined that there is an unused unit subchannel and there is a new user, reallocating the unused unit subchannel to the new user.

35. The method of claim 32, wherein the DCA scheme comprises:
determining use and nonuse of the allocated unit subchannels and presence and absence of a new user at resource allocation periods;
if it is determined that there is a need for reallocation of the allocated unit subchannels, resetting allocation of the allocated unit subchannels, and reallocating the unit subchannels.

36. The method of claim 32, wherein the reallocation of the unit subchannels according to a resource allocation sequence comprises reallocating the unit subchannels according to a sequence which is defined in each cell in an allocation order of the unit subchannels depending on identifier information of the multiple cells.

37. A system for using resources in a multi-cell communication system, the system comprising:
a scheduler for dividing a frequency band used in the multi-cell communication system into a plurality of unit subchannels, and allocating the unit subchannels according to a sequence which is predefined in each cell in an allocation order of the unit subchannels depending on identifier information of the multiple cells.

38. The system of claim 37, wherein the predefined sequence is combined with at least one sequence having a predetermined length, wherein a total length of the combined sequences is equivalent to a total number of the unit subchannels.

39. The system of claim 37, wherein the predefined sequence is combined with at least one sequence having a predetermined length, wherein a total length of the combined sequences is less than a total number of the unit subchannels.

40. The system of claim 39, wherein the predefined sequence is defined in one of a consecutive partial frequency band and an inconsecutive partial frequency band in the communication system.

41. The system of claim 37, wherein the unit subchannel includes a predetermined number of subcarriers or segment bands.

42. The system of claim 37, wherein the unit subchannel is defined such that it has the same configuration or different configurations in all of the multiple cells.

43. The system of claim 37, wherein the unit subchannel is defined such that it has the same configuration in all cells in a first group and a second group, each having predetermined cells among the multiple cells.

44. The system of claim 37, wherein the unit subchannel is defined such that it has different configurations in predetermined adjacent cells among the multiple cells.

45. The system of claim 37, wherein the scheduler sequentially allocates the unit subchannels with the same sequence in all of the multiple cells.

46. The system of claim 37, wherein the scheduler sequentially allocates the unit subchannels with different sequences in all of the multiple cells.

47. The system of claim 37, wherein the scheduler defines a resource allocation sequence set in units of groups each having predetermined adjacent cells among the multiple cells, and then sequentially allocates unit subchannels corresponding to indexes of the predefined sequence.

48. The system of claim 47, wherein the resource allocation sequence set is defined such that it is equal in all cells in the cell group.

49. The system of claim 47, wherein the resource allocation sequence set is defined such that it is different in predetermined cells in the cell group.

50. The system of claim 47, wherein the scheduler generates at least one sequence pattern determined according to a frequency reuse factor of the multi-cell communication system, by cyclic-shifting the sequence predefined in each cell in a manner of adjusting a sequence allocation start point of the unit subchannels, which is equal in all of the multiple cells, and sequentially allocates the unit subchannels according to the generated sequence pattern.

51. The system of claim 47, wherein the scheduler generates at least one sequence pattern determined according to a frequency reuse factor of the multi-cell communication system, by cyclic-shifting the sequence predefined in each cell in a manner of adjusting a sequence allocation start point of the unit subchannels, which is different in predetermined cells among the multiple cells, and sequentially allocates the unit subchannels according to the generated sequence pattern.

52. The system of claim 47, wherein the scheduler generates at least one sequence pattern determined according to a frequency reuse factor of the multi-cell communication system, by cyclic-shifting t he sequence predefined in each cell in a manner of adjusting a sequence allocation start point of the unit subchannels, which is equal in all cells in a cell group having predetermined adjacent cells among the multiple cells, and sequentially allocates the unit subchannels according to the generated sequence pattern.

53. The system of claim 47, wherein the scheduler generates at least one sequence pattern determined according to a frequency reuse factor of the multi-cell communication system, by cyclic-shifting the sequence predefined in each cell in a manner of adjusting a sequence allocation start point of the unit subchannels, which is different in predetermined cells in a cell group having predetermined cells among the multiple cells, and sequentially allocates the unit subchannels according to the generated sequence pattern.

54. The system of claim 37, wherein the scheduler allocates unit subchannels taking into account at least one of a system requirement of the multi-cell communication system and a user requirement.

55. The system of claim 37, wherein the scheduler defines and combines at least one sequence having a predetermined length according to traffic type of a user, and allocates unit subchannels according to a sequence corresponding to individual traffic, among the combined sequences.

56. The system of claim 55, wherein the scheduler allocates non-allocated unit subchannels for other traffic according to a sequence corresponding to the other traffic, when unit subchannels needed by arbitrary traffic exceed in number the unit subchannels allocated according to a sequence corresponding to the arbitrary traffic.

57. The system of claim 37, wherein the scheduler defines and combines at least one sequence having a predetermined length according to a service class of a user, and allocates unit subchannels according to a sequence corresponding to an individual service class, among the combined sequences.

58. The system of claim 57, wherein the scheduler allocates non-allocated unit subchannels for other service classes according to a sequence corresponding to the other service classes, when unit subchannels needed by an arbitrary service class exceed in number the unit subchannels allocated according to a sequence corresponding to the arbitrary service class.

59. The system of claim 37, wherein the scheduler defines and combines at least one sequence having a predetermined length according to a user group, and allocates unit subchannels according to a sequence corresponding to an individual user group, among the combined sequences.

60. The system of claim 59, wherein the scheduler allocates non-allocated unit subchannels for other user groups according to a sequence corresponding to the other user groups, when unit subchannels needed by an arbitrary user group exceed in number the unit subchannels allocated according to a sequence corresponding to the arbitrary user group.

61. The system of claim 37, wherein the scheduler sequentially allocates unit subchannels according to at least one of a forward sequence, a reverse sequence, a center-direction sequence, an edge-direction sequence, a pseudo random sequence, and a specific code-defined sequence.

62. The system of claim 61, wherein the specific code-defined sequence is a Latin-square code-defined sequence.

63. The system of claim 37, wherein the scheduler allocates the unit subchannels using a Dynamic Channel Allocation (DCA) scheme.

64. The system of claim 63, wherein the scheduler determines use and nonuse of the allocated unit subchannels at resource allocation periods, and reallocates unused unit subchannels according to the determination result.

65. The system of claim 63, wherein the scheduler determines use and nonuse of the allocated unit subchannels and presence and absence of a new user at resource allocation periods, and if it is determined that there is an unused unit subchannel and there is a new user, the scheduler reallocates the unused unit subchannel to the new user.

66. The system of claim 65, wherein if it is determined that there is no unused unit subchannel and there is a new user, the scheduler reallocates a unit subchannel to the new user according to a predefined sequence.

67. The system of claim 63, wherein the scheduler:
determines use and nonuse of the allocated unit subchannels and presence and absence of a new user at resource allocation periods;
if it is determined that there is a need for reallocation of the allocated unit subchannels, resets the sequence predefined in each cell, and redefines a sequence for each cell; and
reallocates the unit subchannels according to the sequence redefined for each cell.
